(19) United States
(12) Patent Application Publication
(10) Pub. No.: US 2022/0190389 A1
(43) Pub. Date: Jun. 16, 2022

(54) ELECTROLYTES FOR LITHIUM-ION BATTERY CELLS WITH VOLUME-CHANGING ANODE PARTICLES

(71) Applicant: Sila Nanotechnologies Inc., Alameda, CA (US)

(72) Inventors: Gleb YUSHIN, Atlanta, GA (US); Kostiantyn TURCHENIUK, Oakland, CA (US); Judith KIM, San Leandro, CA (US); David BRITT, El Cerrito, CA (US)

(21) Appl. No.: 17/643,737

(22) Filed: Dec. 10, 2021

Related U.S. Application Data
(60) Provisional application No. 63/124,441, filed on Dec. 11, 2020.

(51) Int. Cl. H01M 10/0569; H01M 10/0525; H01M 10/0568

(52) U.S. Cl. CPC H01M 10/0569; H01M 2004/021; H01M 10/0568; H01M 10/0525

(57) ABSTRACT

A Li-ion battery cell includes anode and cathode electrodes, a separator electrically separating the anode electrode and the cathode electrode, and an electrolyte ionically coupling the anode electrode and the cathode electrode. In some designs, the anode electrode has a capacity loading in the range of about 2 mAh/cm² to about 10 mAh/cm² and includes anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g.

### CROSS-REFERENCE TO RELATED APPLICATIONS

The present application for patent claims the benefit of U.S. Provisional Application No. 63/124,441, entitled “ELECTROLYTES FOR LITHIUM-ION BATTERY CELLS WITH VOLUME-CHANGING ANODE PARTICLES,” filed Dec. 11, 2020, assigned to the assignee hereof, and expressly incorporated herein by reference in its entirety.

### BACKGROUND

### Field

Aspects of the present disclosure relates generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicle, grid storage and other important applications.

However, despite the increasing commercial prevalence of batteries, further development of these batteries is needed, particularly for applications in low- or zero-emission, hybrid-electrical or fully-electrical vehicles, consumer electronics, wearable devices, energy-efficient cargo ships and locomotives, drones, aerospace applications, and power grids. In particular, further improvements are desired for various rechargeable batteries, such as rechargeable Li and Li-ion batteries, rechargeable Na and Na-ion batteries, and rechargeable K and K-ion batteries, to name a few.

A broad range of electrolyte compositions may be utilized in the construction of Li and Li-ion batteries and other metal and metal-ion batteries. However, for improved cell performance (e.g., low and stable resistance, high cycling stability, high rate capability, good thermal stability, long calendar life, etc.), the optimal choice of electrolyte needs to be developed for specific types and specific sizes of active particles in both the anode and cathode, specific total battery cell capacities as well as the specific operational conditions (e.g., temperature, charge rate, discharge rate, voltage range, capacity utilization, etc.). In many cases, the choice of electrolyte components and their ratios is not trivial and can be counter-intuitive.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries. Unfortunately, Li and Li-ion battery cells with such anodes and conventional electrolytes often require the use of such large amounts of conventional solid electrolyte interphase (SEI)-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V. Higher cell voltage, broader operational temperature window and longer cycle life, however, are advantageous for most applications. Such cells may suffer from excessive capacity degradation (e.g., above about 5%), large volume expansion (e.g., above about 10%) and significant gassing when exposed to high temperatures (e.g., above about 50-90° C.) in a fully charged state (e.g., about 90-100% state-of-charge, SOC) for a prolonged time (e.g., about 12-168 hours). Passing such elevated temperature charging tests is often required for most applications. Performance of such cells may also become particularly poor when the anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs.

In certain types of rechargeable batteries, charge storing anode materials may be produced as high-capacity (nano)composite powders, which exhibit moderately high volume changes (e.g., about 8-180 vol. %) during the first charge-discharge cycle and moderate volume changes (e.g., about 5-50 vol. %) during the subsequent charge-discharge cycles. A subset of such charge-storing anode particles includes anode particles with an average size (e.g., diameter or thickness) in the range of about 0.2 to about 40 microns. Such a class of charge-storing particles offers great promises for scalable manufacturing and achieving high cell-level energy density and other performance characteristics. Unfortunately, such particles are relatively new and their use in cells using conventional electrolytes may result in relatively poor cell performance characteristics and limited cycle stability. Performance of such battery cells may become particularly poor when the cells are charged to above about 4.1-4.3 V, more so when the cells are charged to above about 4.3-4.4V and even more so when the cells are charged to above about 4.5 V. Higher cell voltage, broader operational temperature window and longer cycle life, however, is advantageous for most applications. Such cells may suffer from excessive capacity degradation (e.g., above about 5%), large volume expansion (e.g., above about 10%) and significant gassing when exposed to high temperatures (e.g., above about 50-90° C.) in a fully charged state (e.g., about 90-100% state-of-charge, SOC) for a prolonged time (e.g., about 12-168 hours). Passing such elevated temperature charging tests is often required for most applications. Cell performance may also become particularly poor when the high-capacity (nano)composite anode capacity loading (areal capacity) becomes moderate (e.g., about 2-4 mAh/cm²) and even more so when the areal capacity becomes high (e.g., about 4-12 mAh/cm²). Higher capacity loading, however, is advantageous for increasing cell energy density and reducing cell manufacturing costs. Similarly, cell performance may degrade when the porosity of such an anode (e.g., the volume occupied by the spacing between the (nano)composite active anode particles in the electrode and filled with electrolyte) becomes moderately small (e.g., about 25-35 vol. % after the first charge-discharge cycle) and more so when the porosity of the anode becomes small (e.g., about 5-25 vol. % after the first charge-discharge cycle) or when the amount of a binder and conductive additives in the electrode becomes moderately small (e.g., about 5-15 wt. %) and more so when the amount of the binder and conductive additives in the electrode becomes small (e.g., about 0.5-5 wt. %). Higher electrode density and lower binder and conductive additive content, however, are advantageous for increasing cell energy density and reducing cost. Lower binder content may also be advantageous for increasing cell rate performance.

Examples of materials that exhibit moderately high volume changes (e.g., about 8-180 vol. %) during the first charge-discharge cycle and moderate volume changes (e.g., about 5-50 vol. %) during the subsequent charge-discharge cycles include (nano)composites comprising so-called conversion-type (which includes both so-called chemical transformation and so-called “true conversion” sub-classes) and so-called alloying-type active electrode materials. In the case of metal-ion batteries (such as Li-ion batteries), examples of such conversion-type active electrode materials include, but are not limited to, metal fluorides (such as lithium fluoride, iron fluoride, cupper fluoride, bismuth fluoride, their mixtures and alloys, etc.), metal chlorides, metal iodides, metal bromides, metal chalcogenides (such as sulfides, including lithium sulfide and other metal sulfides), sulfur, selenium, metal oxides (including but not limited to lithium oxide and silicon oxide), metal nitrides, metal phosphides (including lithium phosphide), metal hydrides, and others. In the case of metal-ion batteries (such as Li-ion batteries), examples of such alloying-type electrode materials include, but are not limited to, silicon, germanium, antimony, aluminum, magnesium, zinc, gallium, arsenic, phosphorous, silver, cadmium, indium, tin, lead, bismuth, their alloys, and others. These materials typically offer higher gravimetric and volumetric capacity than so-called intercalation-type electrodes commonly used in commercial metal-ion (e.g., Li-ion) batteries. Alloying-type electrode materials are particularly advantageous for use in certain high-capacity anodes for Li-ion batteries. Silicon-based alloying-type anodes may be particularly attractive for such applications.

Accordingly, there remains a need for improved batteries, components, and other related materials and manufacturing processes.

### SUMMARY

Embodiments disclosed herein address the above stated needs by providing improved batteries, components, and other related materials and manufacturing processes.

An aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size (e.g., volume-weighted mean particle diameter) in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g (normalized by the weight of the anode particles), a separator electrically separating the anode electrode and the cathode electrode, and an electrolyte ionically coupling the anode electrode and the cathode electrode, wherein the electrolyte comprises one or more metal-ion salts (e.g., one, two, three or more Li salts with the total concentration in the range from about 0.8M to about 2.0M) and a solvent composition, the solvent composition comprising one, two or more cyclic carbonates, zero, one, two, three or more nitrogen-comprising co-solvents, zero, one, two, three or more sulfur comprising co-solvents, and one or more electrolyte co-solvents, at least one of the electrolyte co-solvents having the formula of:

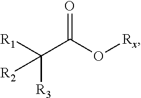

wherein where R₁, R₂, and R₃ are independently selected (e.g., as used herein, “independently selected” means that R₁, R₂, and R₃ can be the same or different, and the selection(s) of the material(s) for R₁, R₂, and R₃ can be made separately) from: H, C₁₋₅ alkyl, halogen, cyano, sulfonyl, alkoxy, trifluoroalkyl, difluoroalkyl, monofluoroalkyl, cycloalkyl, aryl, and aryloxy, and wherein Rₓ is C₁₋₅ alkyl.

Another aspect is directed to a Li-ion battery cell, comprising anode and cathode electrodes, wherein the anode electrode has an areal capacity loading in the range of about 2 mAh/cm² to about 10 mAh/cm² and comprises anode particles that (i) have an average particle size (e.g., volume-weighted mean particle size) in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g (normalized by the weight of the anode particles), a separator electrically separating the anode electrode and the cathode electrode, and an electrolyte ionically coupling the anode electrode and the cathode electrode, wherein the electrolyte comprises one or more metal-ion salts (e.g., one, two, three or more Li salts with the total concentration in the range from about 0.8M to about 2.0M) and a solvent composition, the solvent composition comprising one, two or more cyclic carbonates, zero, one, two, three or more nitrogen-comprising co-solvents, zero, one, two, three or more sulfur comprising co-solvents, and one or more electrolyte co-solvents, at least one of the electrolyte co-solvents having the formula of:

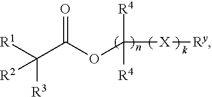

wherein where R¹, R², and R³ are independently selected (e.g., as used herein, “independently selected” means that R₁, R₂, and R₃ can be the same or different, and the selection(s) of the material(s) for R₁, R₂, and R₃ can be made separately) from: H, C₁₋₅ alkyl, halogen, cyano, sulfonyl, alkoxy, trifluoroalkyl, difluoroalkyl, monofluoroalkyl, cycloalkyl, aryl, and aryloxy, wherein R⁴ is selected from: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n is in the range from 0 to 5, wherein X is selected from: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k is in the range of 0 to 5, and wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅ alkyl, sulfinyl-C₁₋₅ alkyl, N—C₁₋₅ alkylsulfonyl-C₁₋₅ alkyl, N—C₁₋₅ alkylsulfonyl-aryl, a 5-8 membered saturated or non-saturated S-containing ring, a 5-8 membered saturated or non-saturated P-containing ring.

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size (e.g., volume-weighted mean particle size) in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts (e.g., one, two, three or more Li salts with the total concentration in the range from about 0.8M to about 2.0M) and a solvent composition, the solvent composition comprising one, two or more cyclic carbonates, zero, one, two, three or more nitrogen-comprising co-solvents, zero, one, two, three or more sulfur comprising co-solvents, and one or more electrolyte co-solvents, at least one of the electrolyte co-solvents having the formula of:

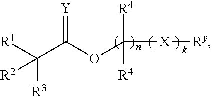

wherein R¹, R², and R³ are independently selected (e.g., as used herein, “independently selected” means that R₁, R₂, and R₃ can be the same or different, and the selection(s) of the material(s) for R₁, R₂, and R₃ can be made separately) from: H, C₁₋₅ alkyl, halogen, cyano, sulfonyl, alkoxy, trifluoroalkyl, difluoroalkyl, monofluoroalkyl, cycloalkyl, aryl, and aryloxy, wherein Y is O, S or Se, or S, wherein Z is O, S, Se or NH, wherein R⁴ is selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n is in the range from 0 to 5, wherein X is selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k is in the range of 0 to 5, and wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkylsulfonyl-C₁₋₅alkyl, N—C₁₋₅alkylsulfonyl-aryl, a 5-8 membered saturated or non-saturated S-containing ring, and a 5-8 membered saturated or non-saturated P-containing ring.

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size (e.g., volume-weighted mean particle size) in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts (e.g., one, two, three or more Li salts with the total concentration in the range from about 0.8M to about 2.0M) and a solvent composition, the solvent composition comprising one, two or more cyclic carbonates, zero, one, two, three or more nitrogen-comprising co-solvents, zero, one, two, three or more sulfur comprising co-solvents, and one or more electrolyte co-solvents, at least one of the electrolyte co-solvents having the formula of:

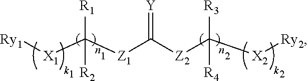

wherein Y is O, S or Se, or S, wherein Z₁ and Z₂ is O, S, Se or NH, wherein R₁, R₂, R₃, and R₄ are independently selected (e.g., as used herein, “independently selected” means that R₁, R₂, R₃, and R₄ can be the same or different, and the selection(s) of the material(s) for R₁, R₂, R₃, and R₄ can be made separately) from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n₁ and n₂ are in the range from 0 to 5, wherein X₁ and X₂ are independently selected (e.g., as used herein, “independently selected” means that X₁ and X₂ can be the same or different, and the selection(s) of the material(s) for X₁ and X₂ can be made separately) from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k₁ and k₂ are in the range of 0 to 5, and wherein Ry₁ and Ry₂ are independently selected (e.g., as used herein, “independently selected” means that Ry₁ and Ry₂ can be the same or different, and the selection(s) of the material(s) for Ry₁ and Ry₂ can be made separately) from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkylsulfonyl-C₁₋₅ alkyl, N—C₁₋₅alkylsulfonyl-aryl, a 5-8 membered saturated or non-saturated S-containing ring, and a 5-8 membered saturated or non-saturated P-containing ring.

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size (e.g., volume-weighted mean particle size) in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts (e.g., one, two, three or more Li salts with the total concentration in the range from about 0.8M to about 2.0M) and a solvent composition, the solvent composition comprising the solvent composition having a density in the range from about 0.8 to about 0.95 g/cc or from about 0.95 g/cc to about 1.00 g/cc or from about 1.00 g/cc to about 1.05 g/cc.

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising one or more cyclic carbonates, and one or more electrolyte co-solvents, at least one of the one or more electrolyte co-solvents having the formula of:

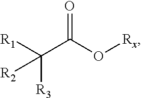

wherein R₁, R₂, and R₃ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy, and wherein Rₓ is C₁₋₅ alkyl. In some aspects, the Li-ion battery cell further comprises one or more nitrogen-comprising co-solvents. In some aspects, the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride. In some aspects, the Li-ion battery cell further comprises one or more sulfur-comprising co-solvents. In some aspects, the Li-ion battery cell the one or more sulfur-comprising co-solvents are selected from tetramethylene sulfone (sulfolane), 1,3,2-dioxathiolane-2,2-dioxide (DTD), methylene methanedisulfonate, tris(trimethylsilyl) phosphite, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides. In some aspects, the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one. In some aspects, the one or more electrolyte co-solvents are selected from methyl 2-methylpropionate, methyl 2,2-dimethylpropionate (methyl isobutyrate), methyl 2-methylbutyrate, ethyl 2-methylpropionate (ethyl isobutyrate), ethyl 2,2-dimethylpropionate, ethyl 2-methylbutyrate, methyl 2-fluoro-2-methylpropionate, methyl 2-fluoropropionate, methyl 2-methyl-3-cyanopropionate, methyl isovalerate, and ethyl isovalerate. In some aspects, the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising one or more cyclic carbonates, and one or more electrolyte co-solvents, at least one of the one or more electrolyte co-solvents having the formula of:

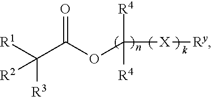

wherein where R¹, R², and R³ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy, wherein R⁴ is selected from: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n is in the range from 0 to 5, wherein X is selected from: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k is in the range of 0 to 5, and wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅ alkyl, N—C₁₋₅ alkylsulfonyl-C₁₋₅alkyl, N—C₁₋₅ alkylsulfonyl-aryl, a 5-8 membered saturated or non-saturated S-containing ring, a 5-8 membered saturated or non-saturated P-containing ring. In a further aspect, the Li-ion battery cell may further comprise one or more nitrogen-comprising co-solvents. In a further aspect, the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride. In a further aspect, the Li-ion battery cell may further comprise one or more sulfur-comprising co-solvents. In a further aspect, the one or more sulfur-comprising co-solvents are selected from tetramethylene sulfone (sulfolane), 1,3,2-dioxathiolane-2,2-dioxide (DTD), methylene methanedisulfonate, tris(trimethylsilyl) phosphite, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides. In a further aspect, the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, dimethyl-1,3-dioxolan-2-one, 4,4-dimethyl-1,3-dioxolan-2-one, and 4-propyl-1,3-dioxolan-2-one. In a further aspect, the one or more electrolyte co-solvents are selected from 2,2,2-trifluoroethyl isobutyrate, 2-cyanoethyl isobutyrate, 2,5-dicyanopentyl isobutyrate, 2-(2,2-dioxido-3H-1,2-oxathiol-4-yl)ethyl isobutyrate, 4-(methyl sulfonyl)benzyl isobutyrate, 2-((difluorophosphoryl)oxy)ethyl isobutyrate, 2-((1,3,2-dioxaphospholan-2-yl)oxy)ethyl isobutyrate, 2-((trimethoxysilyl)oxy)ethyl isobutyrate, 2-(azidomethoxy)ethyl pivalate, allyl isobutyrate, but-2-yn-1-yl propionate, 2,2,2-trifluoroethyl trimethylacetate. In a further aspect, the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising one or more cyclic carbonates, and one or more electrolyte co-solvents, at least one of the electrolyte co-solvents having the formula of:

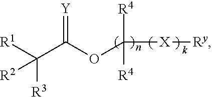

wherein R¹, R², and R³ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy, wherein Y is O, S or Se, or S, wherein Z is O, S, Se or NH, wherein R⁴ is selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n is in the range from 0 to 5, wherein X is selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k is in the range of 0 to 5, and wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅ alkyl, N—C₁₋₅ alkylsulfonyl-C₁₋₅ alkyl, N—C₁₋₅ alkylsulfonyl-aryl, a 5-8 membered saturated or non-saturated S-containing ring, and a 5-8 membered saturated or non-saturated P-containing ring. In a further aspect, the Li-ion battery cell may further comprise one or more nitrogen-comprising co-solvents. In a further aspect, the Li-ion battery cell may further comprise the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride. In a further aspect, the Li-ion battery cell may further comprise one or more sulfur-comprising co-solvents. In a further aspect, the one or more sulfur-comprising co-solvents are selected from tetramethylene sulfone (sulfolane), 1,3,2-dioxathiolane-2,2-dioxide (DTD), methylene methanedisulfonate, tris(trimethylsilyl) phosphite, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides. In a further aspect, the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one. In a further aspect, the Li-ion battery cell may further comprise the one or more electrolyte co-solvents are selected from N-(2,2,2-trifluoroethyl)isobutyramide, N-(2-cyanoethyl)isobutyramide, N-(2,5-dicyanopentyl)isobutyramide, 2-(2,2-dioxido-3H-1,2-oxathiol-4-yl)ethyl 2-methylpropanedithioate, O-(4-(methyl sulfonyl)benzyl) 2-methylpropanethioate, S-(2-((difluorophosphoryl)oxy)ethyl) 2-methylpropanethioate, S-(2-((1,3,2-dioxaphospholan-2-yl)oxy)ethyl) 2-methylpropanethioate, trimethyl (2-propionamidoethyl) silicate, N-(2-(azidomethoxy)ethyl)isobutyramide, S-allyl 2,2-dimethylpropanethioate, and N-(but-2-yn-1-yl)isobutyramide. In a further aspect, the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising one, two or more cyclic carbonates, and one or more electrolyte co-solvents, at least one of the electrolyte co-solvents having the formula of:

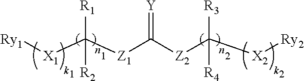

wherein Y is O, S or Se, or S, wherein Z₁ and Z₂ are independently selected from O, S, Se or NH, wherein R₁, R₂, R₃ and R₄ are independently selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy, wherein n₁ and n₂ are integer numbers which are in the range from 0 to 5, wherein X₁ and X₂ are independently selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl, wherein p is the range of 0 to 5, wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl, wherein k₁ and k₂ are integer number which are in the range of 0 to 5, and wherein Ry₁ and Ry₂ are independently selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅ alkyl, N—C₁₋₅ alkylsulfonyl-C₁₋₅ alkyl, N—C₁₋₅ alkylsulfonyl-aryl, a 5-8 membered saturated or non-saturated S-containing ring, and a 5-8 membered saturated or non-saturated P-containing ring. In a further aspect, the Li-ion battery cell may further comprise one or more nitrogen-comprising co-solvents. In a further aspect, the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride. In a further aspect, the Li-ion battery cell may further comprise one or more sulfur-comprising co-solvents. In a further aspect, the one or more sulfur-comprising co-solvents are selected from tetramethylene sulfone (sulfolane), 1,3,2-dioxathiolane-2,2-dioxide (DTD), methylene methanedisulfonate, tris(trimethylsilyl) phosphite, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides. In a further aspect, the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one. In a further aspect, the one or more electrolyte co-solvents are selected from bis(4-(methyl sulfonyl)benzyl) carbonate, 2,2,2-trifluoroethyl (2-cyanopropyl)carbamate, cyanomethyl (2-((trimethoxysilyl)oxy)ethyl) carbonate, 2-(2,2-dioxido-3H-1,2-oxathiol-4-yl)ethyl methyl carbonate, and S-allyl methylcarbamothioate. In a further aspect, the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

Another aspect is directed to a Li-ion battery cell, comprising anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g, a separator electrically separating the anode electrode and the cathode electrode, and an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition having a density in the range from about 0.8 g/cc to about 0.95 g/cc or from about 0.95 g/cc to about 1.00 g/cc or from about 1.00 g/cc to about 1.05 g/cc.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery cell in which the components, materials, methods, and other techniques described herein may be implemented.

FIGS. 2-9 illustrate selected examples of suitable electrolyte components.

FIG. 10A shows graphical plots of the capacity retention and number of cycles to 80% capacity (N80) for Li-ion battery cells comprising Electrolytes (ELY) #1, #2, and #3, respectively, showing the positive impact of including a branched ester EI in the electrolyte.

FIG. 10B shows a table listing the composition of the respective Electrolytes (ELY) #1, #2, and #3 and the measured cycle life (number of cycles to 80% of the initial capacity, or N80, as estimated at cycle 500) upon testing Li-ion battery cells comprising the respective electrolytes of FIG. 10A.

FIG. 11A shows graphical plots of the capacity retention and number of cycles to 80% capacity (N80) for Li-ion battery cells comprising Electrolytes (ELY) #3 and #4, respectively, showing the positive impact of including a suitable mixture of a branched ester EI and a linear ester EP in the electrolyte.

FIG. 11B shows a table listing the composition of the respective Electrolytes (ELY) #3 and #4 and the measured cycle life (number of cycles to 80% of the initial capacity, or N80, as estimated at cycle 580) upon testing Li-ion battery cells comprising the respective electrolytes of FIG. 11A.

FIG. 12A shows graphical plots of the capacity retention and number of cycles to 80% capacity (N80) for Li-ion battery cells comprising Electrolytes (ELY) #5 and #6, respectively, showing the positive impact of including a branched ester EIV in the electrolyte.

FIG. 12B shows a table listing the composition of the respective Electrolytes (ELY) #5 and #6 and the measured cycle life (number of cycles to 80% of the initial capacity, or N80, as estimated at cycle 200) upon testing Li-ion battery cells comprising the respective electrolytes of FIG. 12A.

FIG. 13 shows a table listing the composition of Electrolytes (ELY) #7 and #8 and the measured thickness change (expressed as % change of the cell thickness measured at 50% State-of-health relative to the initial cell thickness) of Li-ion battery cells comprising the respective electrolytes. The data shows the positive impact of including a mixture of branched ester EI and another branched ester having the structure of Formula 2 (400).

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., . . . from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, etc.).

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

While the description below may describe certain examples in the context of some specific alloying-type and conversion-type chemistries of anode and cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type). This process is also accompanied by breaking chemical bonds and forming new ones. During (e.g., Li-ion) battery operation, Li ions are inserted into alloying type materials forming lithium alloys (hence the name “alloying”-type). Sometimes, “alloying”-type electrode materials are considered to be a subclass of “conversion”-type electrode materials.

While the description below may describe certain examples of suitable intercalation-type cathodes (including high voltage cathodes) in the context of lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM or NMC), lithium cobalt oxide (LCO), lithium cobalt aluminum oxides (LCAO), lithium manganese phosphate (LMP), lithium iron manganese phosphate (LFMP), lithium vanadyl phosphate (LVOP), lithium cobalt phosphate (LCP), lithium iron phosphate (LFP) and other lithium transition metal (TM) oxide or phosphate or sulfate or silicate (or mixed) cathodes that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.), it will be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, Sn, Si, or Ge).

Note that the at. %, wt. % and/or vol. % of electrolyte solvents in a battery cell may change after the so-called “formation” (e.g., initial charge and discharge, degassing and aging at the factory) and/or after initial cycling of the battery cells. It shall be understood that the wt. % or vol. % of the suitable solvents described in this disclosure refer to the electrolyte composition either before “factory formation” or after the “factory formation” or both before and after “factory formation”, but before cycling by customers. However, typically during cycling by customers the cell electrolyte composition changes very gradually and thus investigation (analysis) of electrolyte composition of cycled cells may provide a reasonable indication of the electrolyte composition before such cycling.

While the description below may describe certain embodiments in the context of improved battery cells, it will be appreciated that improved battery modules or packs may be enabled with different aspects of the disclosed technologies and thus are similarly disclosed. Such modules or packs, for example, may be smaller, lighter, safer, simpler, less expensive, provide more energy, provide longer cycle life, provide longer calendar life, provide better operation at high temperatures and/or other important features. It will similarly be appreciated that improved electronic devices, improved electric scooters, electric bicycles, electric cars, electric trucks, electric buses, electric ships, electric planes and, more broadly, improved electric and hybrid electric ground, sea, and aerial (flying) vehicles (including heavy vehicles, autonomous vehicles, unmanned vehicles, planes, space vehicles, satellites, submarines, etc.), improved robots, improved stationary home or stationary utility energy storage units and improved other end products are disclosed, such as those that incorporate cells improved using different aspects of the disclosed technologies. Such devices may be smaller, lighter, offer longer range, faster charging, faster acceleration, better operation at different temperatures, lower cost, longer calendar life, slower degradation with repeated charging and discharging, better safety, etc.

Various embodiments described below may be either advantageously combined or used on their own for the improved performance of battery components, battery cells, battery modules and packs and battery-powered devices, in various designs.

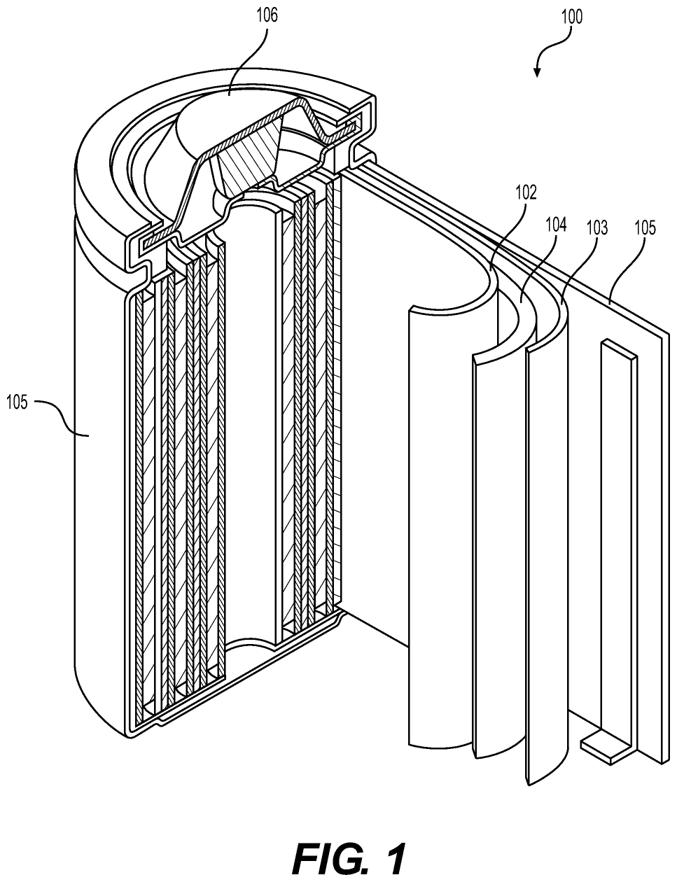

FIG. 1 illustrates an example metal-ion (e.g., Li-ion) battery cell in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Conventional electrolytes for Li- or Na-based batteries of this type are generally composed of an about 0.8-1.2 M (about 1M±about 0.2 M) solution of a single Li or Na salt (such as LiPF₆ for Li-ion batteries and NaPF₆ or NaClO₄ salts for Na-ion batteries) in a mixture of carbonate solvents with about 1-2 wt. % of other organic additives. Common organic additives may include nitriles, esters, sulfones, sulfoxides, phosphorous-based solvents, silicon-based solvents, ethers, and others. Such additive solvents may be modified (e.g., sulfonated or fluorinated).

The conventional salt used in most conventional Li-ion battery electrolytes is LiPF₆. Examples of less common salts (e.g., explored primarily in research publications or, in some cases, never even described in Li-ion battery electrolyte applications, but may still be applicable and useful) include: lithium tetrafluoroborate (LiBF₄), lithium perchlorate (LiClO₄), lithium hexafluoroantimonate (LiSbF₆), lithium hexafluorosilicate (Li₂SiF₆), lithium hexafluoroaluminate (Li₃AlF₆), lithium bis(oxalato)borate (LiB(C₂O₄)₂, lithium difluoro(oxalate)borate (LiBF₂(C₂O₄)), various lithium imides (such as SO₂FN⁻(Li⁺)SO₂F, CF₃SO₂N⁻(Li⁺)SO₂CF₃, CF₃CF₂SO₂N⁻(Li⁺)SO₂CF₃, CF₃CF₂SO₂N⁻(Li⁺)SO₂CF₂CF₃, CF₃SO₂N⁻(Li⁺)SO₂CF₂OCF₃, CF₃OCF₂SO₂N⁻(Li⁺)SO₂CF₂OCF₃, C₆F₅SO₂N⁻(Li⁺)SO₂CF₃, C₆F₅SO₂N⁻(Li⁺)SO₂C₆F₅ or CF₃SO₂N⁻(Li⁺)SO₂PhCF₃, and others), lithium difluorophosphate, and others.

Electrodes utilized in Li-ion batteries are typically produced by (i) formation of a slurry comprising active materials, conductive additives, binder solutions and, in some cases, surfactant or other functional additives; (ii) casting the slurry onto a metal foil (e.g., Cu foil for most anodes and Al foil for most cathodes); and (iii) drying the casted electrodes to completely evaporate the solvent.

Conventional anode materials utilized in Li-ion batteries are of an intercalation-type. Metal ions are intercalated into and occupy interstitial positions of such materials during the charge or discharge of a battery. Such anodes experience small or very small volume changes when used in electrodes. Polyvinylidene fluoride, or polyvinylidene difluoride (PVDF), and carboxymethyl cellulose (CMC) are the two most common binders used in these electrodes. Carbon black is the most common conductive additive used in these electrodes. However, such anodes exhibit relatively small gravimetric and volumetric capacities (typically less than about 370 mAh/g rechargeable specific capacity in the case of graphite- or hard carbon-based anodes and less than about 600 mAh/cm³ rechargeable volumetric capacity at the electrode level without considering the volume of the current collector foils).

Alloying-type (or, more broadly, conversion-type) anode materials for use in Li-ion batteries offer higher gravimetric and volumetric capacities compared to intercalation-type anodes. For example, Earth-abundant silicon (Si) offers approximately 10 times higher gravimetric capacity and approximately 3 times higher volumetric capacity compared to an intercalation-type graphite (or graphite-like) anode. However, Si suffers from significant volume expansion during Li insertion (up to approximately 300 vol. %) and thus may induce thickness changes and mechanical failure of Si-comprising anodes. In addition, Si (and some Li—Si alloy compounds that may form during lithiation of Si) suffer from relatively low electrical conductivity and relatively low ionic (Li-ion) conductivity. Electronic and ionic conductivity of Si is lower than that of graphite. Formation of (nano)composite Si-comprising particles (including, but not limited to Si-carbon composites, Si-metal composites, Si-polymer composites, Si-ceramic composites, composites comprising various combinations of nanostructured Si, carbon, polymer, ceramic and metal or other types of porous composites comprising nanostructured Si or nanostructured or nano-sized Si particles of various shapes and forms) may reduce volume changes during Li-ion insertion and extraction, which, in turn, may lead to better cycle stability in rechargeable Li-ion cells. In some designs, Si may be doped or heavily doped with nitrogen (N), phosphorous (P), boron (B) or other elements or be allowed with metals. In addition to Si-based composites, silicon oxides (SiOₓ) or oxynitrides (SiOₓN_{y}) or nitrides (SiN_{y}) or other Si element-comprising particles (including those that are partially reduced by Li or Mg) may reduce volume changes and improve cycle stability, although commonly at the expense of higher first cycle losses or faster degradation or both. In some designs, Si-comprising anode particles may exhibit high gravimetric capacities in the range from about 800 mAh/g to about 3000 mAh/g (per mass of Si-comprising anode particles in a Li-free state). Such high specific capacity is advantageous for attaining lighter batteries. However, Li-ion battery cells with anodes comprising high capacity anode particles may exhibit undesirably fast degradation in conventional electrolytes, particularly at elevated temperatures or when charged to high voltages (e.g., above about 4-4.3 V). A subset of anodes with Si-comprising anode particles includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offer great potential for increasing gravimetric and volumetric energy of rechargeable batteries. However, Li-ion battery cells with anodes comprising high capacity anode particles may exhibit undesirably fast degradation in conventional electrolytes, particularly at elevated temperatures or when charged to high voltages (e.g., above about 4-4.3 V). In addition to Si-comprising anodes, other examples of such high capacity (e.g., nanocomposite) anodes comprising alloying-type (or, more broadly, conversion-type) active materials include, but are not limited to, those that comprise germanium, antimony, aluminum, magnesium, zinc, gallium, arsenic, phosphorous, silver, cadmium, indium, tin, lead, bismuth, their alloys, and others. In addition to anodes comprising active materials in the metallic form, other interesting types of high capacity (including nanocomposite) anodes may comprise metal oxides (including silicon oxide, lithium oxide, etc.), metal nitrides (including silicon nitride, etc.), metal oxy-nitrides (including silicon oxy-nitride, etc.), metal phosphides (including lithium phosphide), metal hydrides, and others.

Li-ion cells with alloying-type (or, more broadly, conversion-type) active anode materials may exhibit undesirably fast degradation in conventional electrolytes, particularly at elevated temperatures or when charged to high voltages (e.g., above about 4-4.3 V) and stored at such voltages at elevated temperatures (e.g., above about 50-80° C.). In some designs, degradation of Li-ion cells with alloying-type (or, more broadly, conversion-type) active anode materials may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). However, large, or ultra-large or gigantic cells may be particularly attractive for use in some electric transportation or grid storage applications. In some designs, degradation of Li-ion cells with alloying-type (or, more broadly, conversion-type) active anode materials may become particularly undesirably fast for cells comprising medium (e.g., about 3-4 g/Ah) or small (e.g., about 2-3 g/Ah) amount of electrolyte when normalized by total cell capacity. However, using medium or small amount of electrolyte may be particularly attractive for reducing cell fabrication costs or certain side reactions and for maximizing energy density of cells. One or more aspects of the present disclosure enables one to mitigate or overcome some or all of such limitations and substantially enhance performance of such Li-ion cells by using certain disclosed electrolyte compositions.

High-capacity (nano)composite anode powders (including, but not limited to those that comprise Si), which exhibit moderately high volume changes (e.g., about 8-about 180 vol. %) during the first charge-discharge cycle, moderate volume changes (e.g., about 4-about 50 vol. %) during the subsequent charge-discharge cycles and an average size (e.g., volume-weighted mean size) in the range from about 0.2 to about 40 microns (for some applications, more preferably from about 0.4 to about 20 microns) may be particularly attractive for battery applications in terms of manufacturability and performance characteristics. In particular, a sub-class of such anode powders with specific surface area in the range from about 0.5 m²/g to about 50 m²/g (in some designs, from about 0.5 m²/g to about 2 m²/g; in other designs, from about 2 m²/g to about 12 m²/g; in yet other designs, from about 12 m²/g to about 50 m²/g) performed particularly well in some embodiments. In some designs, electrodes with electrode areal capacity loading from moderate (e.g., from about 2 to about 4 mAh/cm²) to high (e.g., from about 4 to about 12 mAh/cm²) and ultra-high (above about 12 mAh/cm²) are also particularly attractive for use in cells. In some designs, a near-spherical or a spheroidal or an ellipsoid (inc. oblate spheroid) shape of these composite particles may additionally be very attractive for increasing rate performance and volumetric capacity (density) of the electrodes.

In spite of some improvements that may be achieved with the formation and utilization of such alloying-type (or conversion-type) active material(s)′ comprising (e.g., nanocomposite) anode materials as well as electrode formulations, however, substantial additional improvements in cell performance characteristics may be achieved with the improved composition and preparation of electrolytes (e.g., liquid electrolytes), beyond what is known or shown by the conventional state-of-the-art. Unfortunately, high-capacity (nano)composite anode and cathode powders, which exhibit moderately high volume changes (e.g., about 8-about 180 vol. %) during the first charge-discharge cycle, moderate volume changes (e.g., about 4-about 50 vol. %) during the subsequent charge-discharge cycles, an average size in the range from about 0.2 to about 40 microns and relatively low density (e.g., about 0.5-3.8 g/cc), are relatively new and their performance characteristics and limited cycle stability are typically relatively poor, particularly if electrode areal capacity loading is moderate (e.g., from about 2 to about 4 mAh/cm²) and even more so if it is high (e.g., from about 4 to about 12 mAh/cm²) or ultra-high. Higher capacity loading, however, is advantageous for increasing cell energy density and reducing cell manufacturing costs. Similarly, the cell performance may suffer when such an electrode (e.g., anode) porosity (volume occupied by the spacing between the (nano)composite active anode particles in the electrode and filled with electrolyte) becomes moderately small (e.g., about 25-about 35 vol. %) and more so when it becomes small (e.g., about 5-about 25 vol. %) or when the amount of the binder and conductive additives in the electrode becomes moderately small (e.g., about 6-about 15 wt. %, total) and more so when it becomes small (e.g., about 0.5-about 5 wt. %, total).

Higher electrode density and lower binder content, however, are advantageous for increasing cell energy density and reducing cost in certain applications. Lower binder content may also be advantageous for increasing cell rate performance. Larger volume changes lead to inferior performance in some designs, which may be related to damages in the solid electrolyte interphase (SEI) layer formed on the anode, to the non-uniform lithiation and de-lithiation of the electrode particles within the electrodes, and other factors. Unfortunately, Li and Li-ion battery cells with such anodes and conventional electrolytes often require the use of such large amounts of conventional SEI-building additives to maintain acceptable cycle stability that prevents their use at elevated or low temperatures or undesirably limits their calendar life or does not allow such cells to be charged to high voltages (e.g., above about 4.1-4.3 V). Performance of such battery cells may become particularly poor when the cells are charged to above about 4.3-4.4 V and even more so when the cells are charged to above about 4.5 V.

Higher cell voltage, broader operational temperature window and longer cycle life, however, is advantageous for most applications. Such cells may suffer from excessive capacity degradation (e.g., above about 5%), large volume expansion (e.g., above about 10%) and significant gassing when exposed to high temperatures (e.g., above about 50-90° C.) in a fully charged state (e.g., about 90-100% state-of-charge, SOC) for a prolonged time (e.g., about 12-168 hours). Passing such elevated temperature charging tests is often required for most applications. In some designs, degradation of Li-ion cells comprising high-capacity (nano)composite anode powders, which exhibit moderately high volume changes during the first charge-discharge cycle, moderate volume changes during the subsequent charge-discharge cycles and an average size in the range from about 0.2 to about 40 microns may become particularly undesirably fast for large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more). In some designs, degradation of Li-ion cells with such volume changing anode particles may become particularly undesirably fast for cells comprising medium (e.g., about 3-4 g/Ah) or small (e.g., about 2-3 g/Ah) amount of electrolyte when normalized by total cell capacity. One or more embodiments of the present disclosure enables one to mitigate or overcome some or all of such limitations and substantially enhance performance of such Li-ion cells by using certain disclosed electrolyte compositions.

In some designs, certain (e.g., aqueous) anode binder compositions may be particularly advantageous for use in high-capacity (e.g., Si-containing) anodes (e.g., for anodes comprising particles that exhibit a specific capacity in the range of about 800 mAh/g to about 3000 mAh/g when normalized by such particle weight or for anodes that exhibit a specific capacity in the range of about 400 mAh/g to about 2800 mAh/g per total mass of the electrode layer, not counting the mass of the current collector, in a Li-free state) because such binder may enable longer cycle stability at near-room temperature or higher volumetric packing (and thus higher volumetric capacity) of such anodes or other benefits. Illustrative examples of such anode binder compositions may include (but are not limited to) binders that comprise one, two or more of the following components (e.g., in a mixture or as a part of the co-polymer, etc.): polyacrylic acid (PAA), Li-salt of a PAA, Na salt of a PAA, K-salt of a PAA, ammonium (NH₄) salt of PAA, Ca-salt of a PAA, polyvinyl alcohol (PVA), alginic acid, Li salt of alginic acid (Li alginate), Na salt of alginic acid, K salt of alginic acid, ammonium (NH₄) salt, Ca salt of alginic acid, carboxymethyl cellulose (CMC) with various degree of OH group substitutions, among others. Unfortunately, when conventional electrolyte-based cells built with such binder-comprising anodes are charged to a high voltage and/or exposed to high temperatures, the conventional electrolyte-based cells may suffer from undesirably fast degradation or excessive gassing (e.g., evolution of hydrogen or other gasses) or other undesirable phenomena. One or more aspects of the present disclosure enables one to mitigate or overcome some or all of such limitations and substantially enhance performance of such Li-ion cells by using certain disclosed electrolyte compositions.

One or more embodiments of the present disclosure overcome some of the above-discussed challenges of various types of metal-ion (e.g., Li-ion) cells comprising high-capacity nanocomposite anode materials (for example, materials comprising conversion-type or alloying-type active materials) that may comprise Si in their composition, may experience certain volume changes during cycling (for example, moderately high volume changes (e.g., about 8-about 160 or about 180 vol. %) during the first charge-discharge cycle and moderate volume changes (e.g., about 4-about 50 vol. %) during the subsequent charge-discharge cycles), may exhibit an average particle size (e.g., volume-weighted mean size) in the range from about 0.2 to about 40 microns and a specific surface area in the range from about 0.5 to about 50 m²/g (in some designs, from about 0.5 to about 2 m²/g; in other designs, from about 2 to about 12 m²/g; in yet other designs, from about 12 to about 50 m²/g), may be formulated with such electrodes in moderate (e.g., about 2-about 4 mAh/cm²) and high areal capacity loadings (e.g., about 4-about 12 mAh/cm²) with high packing density (electrode porosity filled with electrolyte in the range from about 5 to about 35 vol. % after the first charge-discharge cycle) and relatively low binder content (e.g., about 0.5-about 14 wt. %), may comprise moderate or small amount of electrolyte per cell capacity (e.g., less than about 4 g/mAh), may be charged to moderately high (e.g., above about 4.1-4.3 V) or high (e.g., above about 4.3-4.4 V) or very high (e.g., above about 4.5-4.8 V) voltages, may be exposed to temperatures above about 40° C. at high state of charge (e.g., about 70-100% SOC) during testing or operation, may be produced as large cells (e.g., cells with cell capacity in the range from about 10 Ah to about 40 Ah) or ultra-large cells (e.g., cells with cell capacity in the range from about 40 Ah to about 400 Ah) or gigantic cells (e.g., cells with cell capacity in the range from about 400 Ah to about 4,000 Ah or even more).

Conventional cathode materials utilized in Li-ion batteries are of an intercalation-type and commonly crystalline and polycrystalline. Such cathodes typically exhibit a highest charging potential of less than about 4.0-4.2 V vs. Li/Li+, gravimetric capacity of less than about 190 mAh/g (based on the mass of active material) and volumetric capacity of less than about 800 mAh/cm³ (based on the volume of the electrode and not counting the volume occupied by the current collector foil). For given anodes, higher energy density in Li-ion batteries may be achieved either by using various high-voltage cathodes (cathodes with a highest charging potential from about 4.0-4.2 V vs. Li/Li+ to about 5.1 V vs. Li/Li+) or by using so-called conversion-type cathode materials (including, but not limited to those that comprise F or S in their composition). Some high-voltage intercalation-type cathodes may comprise nickel (Ni). Some high-voltage intercalation-type cathodes may comprise manganese (Mn). Some high-voltage intercalation-type cathodes may comprise iron (Fe). Some high-voltage intercalation-type cathodes may comprise vanadium (V). Some high-voltage intercalation-type cathodes may comprise cobalt (Co). Some high-voltage intercalation-type cathodes may comprise aluminum (Al). Some high-voltage intercalation-type cathodes may comprise niobium (Nb). Some high-voltage intercalation-type cathodes may comprise magnesium (Mg). Some high-voltage intercalation-type cathodes may comprise silicon (Si), tin (Sn), antimony (Sb) or germanium (Ge) or their various combinations. In some designs, high-voltage intercalation-type cathode particles may comprise fluorine (F) in their structure or the surface layer. Some high-voltage intercalation-type cathodes may comprise phosphorous (P). Some high-voltage intercalation-type cathodes may comprise sulfur (S). Some high-voltage intercalation-type cathodes may comprise selenium (Se). Some high-voltage intercalation-type cathodes may comprise tellurium (Te). Some high-voltage intercalation-type cathodes may comprise iron (Fe). Some high-voltage intercalation-type cathodes may comprise magnesium (Mg). Some high-voltage intercalation-type cathodes may comprise zirconium (Zr). Combination of such (or similar) types of higher energy density cathodes with high-capacity (e.g., Si based) anodes may result in high cell-level energy density. Unfortunately, the cycle stability and other performance characteristics of such cells may not be sufficient for some applications, at least when used in combination with conventional electrolytes.

One or more embodiments of the present disclosure are thereby directed to electrolyte compositions that work well for a combination of high voltage intercalation cathodes (cathodes with the highest charging potential in the range from about 4.0-4.2 V to about 4.5 V vs. Li/Li+ and, in some cases, from about 4.5 V vs. Li/Li+ to about 5.1 V vs. Li/Li+) with a sub-class of high-capacity moderate volume changing anodes (e.g., anodes comprising (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles), which exhibit an average particle size (e.g., average diameter) in the range from about 0.2 to about 40 microns and specific surface area in the range from about 0.5 to about 50 m²/g (when normalized by the mass of the composite electrode particles) and, in the case of Si-comprising anodes, specific capacities in the range from about 400 to about 2800 mAh/g (when normalized by the total mass of all the anode particles, conductive or other additives and binders, but does not include the weight of the current collectors) or in the range from about 650-800 to about 3000 mAh/g (when normalized by the mass of the Si-comprising anode particles only). In at least one embodiment, a particular electrolyte composition may be selected based on the value of the highest cathode charge potential or the highest operating temperature or the longest calendar life requirement.

Examples of high specific and high volumetric capacity conversion-type cathode materials include, but are not limited to, fluorides, chlorides, sulfides, selenides, their various mixtures, composites and others. For example, fluoride-based cathodes may offer outstanding technological potential due to their very high capacities, in some cases exceeding about 300 mAh/g (greater than about 1200 mAh/cm³ at the electrode level). For example, in a Li-free state, FeF₃ offers a theoretical specific capacity of 712 mAh/g; FeF₂ offers a theoretical specific capacity of 571 mAh/g; MnF₃ offers a theoretical specific capacity of 719 mAh/g; CuF₂ offers a theoretical specific capacity of 528 mAh/g; NiF₂ offers a theoretical specific capacity of 554 mAh/g; PbF₂ offers a theoretical specific capacity of 219 mAh/g; BiF₃ offers a theoretical specific capacity of 302 mAh/g; BiF₅ offers a theoretical specific capacity of 441 mAh/g; SnF₂ offers a theoretical specific capacity of 342 mAh/g; SnF₄ offers a theoretical specific capacity of 551 mAh/g; SbF₃ offers a theoretical specific capacity of 450 mAh/g; SbF₅ offers a theoretical specific capacity of 618 mAh/g; CdF₂ offers a theoretical specific capacity of 356 mAh/g; ZnF₂ offers a theoretical specific capacity of 519 mAh/g. AgF and AgF₂ also offer theoretical specific capacities and additionally exhibit very high lithiation potential. Mixtures (for example, in the form of alloys) of fluorides may offer a theoretical capacity approximately calculated according to the rule of mixtures. The use of mixed metal fluorides may sometimes be advantageous (e.g., may offer higher rates, lower resistance, higher practical capacity, or longer stability). The use of metal fluorides mixed with metals may also sometimes be advantageous (e.g., may offer higher rates, lower resistance, higher practical capacity, or longer stability). In a fully lithiated state, metal fluorides convert to a composite comprising a mixture of metal and LiF clusters (or nanoparticles). Examples of the overall reversible reactions of the conversion-type metal fluoride cathodes may include 2Li+CuF₂↔2LiF+Cu for CuF₂-based cathodes or 3Li+FeF₃↔3LiF+Fe for FeF₃-based cathodes. It will be appreciated that metal fluoride-based cathodes may be prepared in Li-free or partially lithiated or fully lithiated states. Another example of a promising conversion-type cathode (or, in some cases, anode) material is sulfur (S) (in a Li-free state) or lithium sulfide (Li₂S, in a fully lithiated state). In order to reduce dissolution of active material during cycling, to improve electrical conductivity, or to improve mechanical stability of S/Li₂S electrodes, one may utilize formation of porous S, Li₂S, porous S—C composites, Li₂S—C composites, porous S-polymer composites, or other composites comprising S or Li₂S, or both.

Note that in some designs, different electrolyte compositions may offer the most favorable performance for cells comprising identical anodes (e.g., Si-comprising nanocomposite anodes) and different cathodes (e.g., intercalation-type, high voltage intercalation-type, conversion type comprising S, conversion-type comprising F, etc.). In some designs, the operating temperature range and calendar life requirements may similarly significantly alter the electrolyte selection.

Unfortunately, many conversion-type electrodes used in Li-ion batteries suffer from performance limitations. Formation of (nano)composites may, at least partially, overcome such limitations. For example, certain (nano)composites may provide reduced voltage hysteresis, improved capacity utilization, improved rate performance, improved mechanical and sometimes improved electrochemical stability, reduced volume changes, and/or other positive attributes. Examples of such composite fluoride-based cathode materials include, but are not limited to, LiF—Cu—Fe—C nanocomposites, LiF—Cu—Fe—Ag—C nanocomposites, LiF—Cu—Fe—Ti—C nanocomposites, LiF—Cu—Fe—Mn—C nanocomposites, FeF₂—C nanocomposites, FeF₃—C nanocomposites, CuF₂—C nanocomposites, CuF₂—C—AlF₃ nanocomposites, CuF₂—C—Al₂O₃ nanocomposites, LiF—Cu—C nanocomposites, LiF—Cu—C-polymer nanocomposites, LiF—Cu-another metal-C-polymer nanocomposites, LiF—Cu-another metal oxide-C-polymer nanocomposites, LiF—Cu-another metal fluoride-C-polymer nanocomposites, LiF—Cu-metal-polymer nanocomposites, LiF—Fe—C-polymer nanocomposites, LiF—Fe-another metal-C-polymer nanocomposites, LiF—Fe-another metal oxide-C-polymer nanocomposites, LiF—Fe-another metal fluoride-C-polymer nanocomposites, LiF—Fe-another metal-polymer nanocomposites, LiF—Fe-another metal-C-polymer nanocomposites, and many other porous nanocomposites comprising LiF, FeF₃, FeF₂, MnF₃, CuF₂, NiF₂, PbF₂, BiF₃, BiF₅, CoF₂, SnF₂, SnF₄, SbF₃, SbF₅, CdF₂, ZnF₂, AgF, AlF₃, AgF₂ or other metal fluorides or their alloys and mixtures, as well as Fe, Mn, Cu, Ni, Pb, Bi, Co, Sn, Sb, Cd, Zn, Ag, Al or other metals or their alloys and mixtures. Such composites may also comprise oxides or oxyfluorides and may comprise conductive (mostly sp²-bonded) carbon. In some examples, metal fluoride nanoparticles may be infiltrated into the pores of porous carbon (for example, into the pores of activated carbon particles) to form these metal fluoride-C or mixed metals-LiF-another metal oxide or metal fluoride-C nanocomposites, among other related compositions. Examples of such composite sulfur-based cathode materials include, but are not limited to, S—C nanocomposites, S-polymer nanocomposites, S—Se—C nanocomposites, S-metal-C nanocomposites, S-metal-C-polymer nanocomposites, S—Se-metal-C nanocomposites, S—Se-metal-polymer nanocomposites, S—Se-metal-C-polymer nanocomposites, S-metal sulfide-C nanocomposites, S-metal selenide-C nanocomposites, S-metal telluride-C nanocomposites, S-metal oxide-C nanocomposites, S-metal nitride-C nanocomposites, S—C nanocomposites, S-polymer nanocomposites, S—Se—C nanocomposites, Li₂S-metal-C nanocomposites, Li₂S-metal-C-polymer nanocomposites, Li₂S—Li₂Se-metal-C nanocomposites, Li₂S—Li₂Se-metal-polymer nanocomposites, Li₂S—Li₂Se-metal-C-polymer nanocomposites, Li₂S-metal sulfide-C nanocomposites, Li₂S-metal oxide-C nanocomposites, Li₂S-metal nitride-C nanocomposites, Li₂S-metal oxy-nitride-C nanocomposites, where metals (or semimetals, in some designs) may be selected from the group comprising Li, Na, Mg, K, Ca, Cs, Ti, V, Fe, Mn, Ni, Co, Cu, Zn, Zr, Al, Sn, Sb, or their alloys and mixtures, among other related compositions.

In some designs, high-capacity (nano)composite cathode particles (e.g., powders), which exhibit moderately high (for a cathode) volume changes (e.g., about 5-about 100 vol. %) during the first charge-discharge cycle, moderate volume changes (e.g., about 3-about 40 vol. %) during the subsequent charge-discharge cycles, and an average size (for example, a diameter, in the case of spherical particles or, a thickness, in the case of flattened particles or diameter, in case of fiber-shaped particles or, an average dimension, in the case of randomly-shaped particles) in the range from about 0.2 micron to about 40 microns may be particularly attractive for battery applications in terms of manufacturability and performance characteristics. In some designs, a near-spherical or a spheroidal or an ellipsoid (e.g., an oblate spheroid) shape of the composite cathode particles is additionally very attractive for optimizing rate performance and volumetric capacity of the electrodes. Despite some improvements that may be achieved with the formation and utilization of such conversion-type nanocomposite cathode materials and electrode optimization, however, additional improvements in cell performance characteristics may be achieved with the improved composition and preparation of electrolytes, beyond what is known or shown or suggested by the conventional state-of-the art.

One or more embodiments of the present disclosure are thereby directed to electrolyte compositions that work well for a combination of (i) a sub-class of high-capacity moderate volume changing cathodes: e.g., cathodes comprising about 5-about 100 wt. % of high capacity conversion-type (nano)composite cathode materials which exhibit moderate volume changes (e.g., about 5-about 50 vol. %) during the first charge-discharge cycle and small-to-moderate volume changes (e.g., about 3-about 40 vol. %) during the subsequent charge-discharge cycles, and an average size (for example, a diameter, in the case of spherical particles) in the range from about 0.2 to about 40 microns with (ii) a sub-class of high-capacity moderate volume changing anodes: e.g., anodes comprising about 5-about 100 wt. % of (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only).

One or more embodiments of the present disclosure are also directed to electrolyte compositions that work well for a combination of (i) a sub-class of moderate capacity (e.g., about 160-260 mAh/g per mass of active materials, in some design), high-voltage intercalation-type cathodes (which may be layered cathodes in some designs; which may comprise Ni or Co or Mn or a combination of some of such metals in some designs, such as, for example, LCO, NCA, NCMA, LNO, LMO, NCM, LCAO, LMP, LFMP, LVOP, LCP, LNP or others), which are charged to above about 4.1 V vs. Li/Li+ during full cell battery cycling (in some designs, above about 4.2 V vs. Li/Li+; in other designs, above 4.3 V vs. Li/Li+; in yet other designs, above about 4.4 V vs. Li/Li+; in yet other designs, above about 4.5 V vs. Li/Li+; in yet other designs, above about 4.6 V vs. Li/Li+) with (ii) a sub-class of high-capacity moderate volume changing anodes: anodes comprising about 5-about 100 wt. % of (nano)composite anode powders, which exhibit moderately high volume changes (e.g., about 8-about 160 or about 180 vol. %) during the first charge-discharge cycle, moderate volume changes (e.g., about 4-about 50 vol. %) during the subsequent charge-discharge cycles, an average size (e.g., average diameter) in the range from about 0.2 to about 40 microns and specific surface area in the range from about 0.5 to about 50 m²/g normalized by the mass of the (nano)composite anode particles and, in the case of Si-comprising anodes, specific reversible capacities in the range from about 400 to about 2800 mAh/g (when normalized by the total mass of all the active electrode particles, conductive additives and binders) or in the range from about 800 to about 3000 mAh/g (when normalized by the mass of the composite anode particles only). In some designs, such Si (element)—comprising anodes may also comprise a polymer/co-polymer binder with functional group(s) comprising a carboxylic acid and/or a salt (e.g., Li, Na, K, Na, NH₄ etc. salt) of a carboxylic acid (e.g., as in a PAA) and/or a hydroxyl group (e.g., as in alcohols, such as PVA, carboxymethyl cellulose, etc.). The inventors have found that, in some designs, cells comprising anode electrodes based on high capacity nanocomposite anode particles or powders (comprising conversion- or alloying-type active anode materials) that experience certain volume changes during cycling (moderately high volume changes (e.g., an increase by about 8-about 180 vol. or a reduction by about 8-about 70 vol. %) during the first charge-discharge cycle and moderate volume changes (e.g., about 4-about 50 vol. %) during the subsequent charge-discharge cycles) and an average size in the range from about 0.2 to about 40 microns (such as Si-based nanocomposite anode powders, among many others) may benefit from specific compositions of electrolytes that provide significantly improved performance (particularly for high capacity loadings or small electrolyte fractions or large cells). In some designs, such anodes may also advantageously comprise a polymer/co-polymer binder with functional groups comprising a carboxylic acid and/or a salt (e.g., a salt comprising Li, Na, K, Na, NH₄, etc.) of a carboxylic acid (e.g., as in a PAA) and/or a hydroxyl group (e.g., as in alcohols, such as PVA, carboxymethyl cellulose, etc.).

For example, (i) continuous volume changes in high capacity nanocomposite particles during cycling in combination with (ii) electrolyte decomposition on the electrically conductive electrode surface at electrode operating potentials (e.g., mostly electrochemical electrolyte reduction in the case of Si-based anodes) may lead to a continuous (even if relatively slow) growth of a solid electrolyte interphase (SEI) layer on the surface of the nanocomposite anode particles and the resulting irreversible losses in cell capacity. In some designs, the addition of some known SEI-forming additives may improve SEI stability during cycling, but may lower electrolyte conductivity and may induce undesirable electrolyte oxidation on the cathode (particularly at higher voltages or elevated temperature), resulting in gassing, cell swelling and reduced cycle and calendar life. In some designs, the addition of some known cathode solid electrolyte interphase (CEI)-forming additives may induce protective film formation on the cathode, reducing further electrolyte oxidation and gassing, but often at the expense of reduced SEI stability on the anode or other undesirable effects.

In some designs, swelling of binders in electrolytes and gassing of binders during cell exposure to elevated temperatures depends not just on the binder composition, but may also depend on the electrolyte compositions. Furthermore, in some designs, such swelling (and the resulting performance reduction) often correlates with the reduction in elastic modulus upon exposure of binders to electrolytes. In this sense, the smaller the reduction in modulus in certain electrolytes, the more stable the binder-linked (nano)composite active particles/conductive additives interface becomes. In some designs, the reduction in binder modulus by over about 15-20% may result in a noticeable reduction in performance. In an example, the reduction in the binder modulus by about two times (2×) may result in a substantial performance reduction. In a further example, the reduction in modulus by about five or more times (e.g., about 5×-500×) may result in a very significant performance reduction. Therefore, selecting an electrolyte composition that does not induce significant binder swelling may be highly preferential for certain applications. In some examples, it may be preferred to select an electrolyte composition that reduces the binder modulus by less than about 30% (more preferably, by no more than about 10%) when exposed to electrolyte. In anodes which comprise more than one binder composition, in some designs, it may be preferred to select an electrolyte composition where at least one binder does not reduce the modulus by over about 30% (more preferably, by no more than about 10%) when exposed to electrolyte.

In one or more embodiments of the present disclosure, favorable electrolyte composition for Li or Li-ion batteries may include a significant fraction (from about 0.1 to about 92 wt. %, as a fraction of all solvents in the electrolyte) of suitable branched esters or related compounds or their mixtures as main solvents/co-solvents or as minor (additive-level) co-solvents. In some designs (depending on the anode and cathode chemistry and maximum cell voltage), the fraction of suitable branched esters or related compounds in the electrolyte solvent may range from about 0.1 to about 5-10 wt. % (as a fraction of all solvents in the electrolyte); in other designs, from about 5-10 to about 30 wt. %; in other designs, from about 30 to about 40 wt. %; in other designs, from about 40 to about 50 wt. %; in other designs, from about 50 to about 60 wt. %; in yet other designs, from about 60 to about 92 wt. %.

In some designs, it may be advantageous for the suitable branched esters or suitable related compounds (or their mixtures) to exhibit a low melting point in the range from about minus (−) 10 to about −120° C. (in some designs, the melting point may preferably be below about −20° C.; in other designs, the melting point may preferably be below about −40° C.; in other designs, the melting point may preferably be below about −60° C.; and in yet other designs, the melting point may preferably be below about −80° C.). In some designs, though, some of the suitable branched esters (particularly if used in smaller wt. fractions) may exhibit higher melting points (e.g., from about −10 to about +40° C.).

In some designs, it may be advantageous (e.g., for better performance cell and battery module and battery pack and battery characteristics) for at least a fraction of the suitable branched esters (e.g., from about 5 to about 20 vol. % or from about 20 to about 50 vol. % or from about 50 to about 90 vol. % or from about 90 to about 100 vol. % of all branched esters in the electrolyte) or suitable related disclosed compounds to comprise from about 4 to about 9 carbon (C) atoms per molecule (in some designs, from about 4 to about 5; in other designs, from about 6 to about 7; in yet other designs, from about 7 to about 9; in yet other designs—in any other range from about 4 to about 9).

In some designs, it may be advantageous for the suitable branched esters or suitable related compounds (or their mixtures) to exhibit a boiling point in the range from about −10 to about +250° C. In some designs, the boiling point may preferably be above +10° C. (note that in other designs, the boiling point may preferably be above about 20° C.; in other designs, the boiling point may preferably be above about 40° C.; in other designs, the boiling point may preferably be above about 60° C.; in other designs, the boiling point may preferably be above about 80° C.; in yet other designs, the boiling point may preferably be above about 100° C.; in other designs, the boiling point may preferably be above about 120° C.; in yet other designs, the boiling point may preferably be above about 150° C.).

In one or more embodiment of the present disclosure, including a suitable fraction of suitable branched esters or suitable related compounds (or their mixtures) into electrolytes may provide multiple benefits to Li or Li-ion batteries, particularly those that comprise a sub-class of high-capacity moderate volume changing anodes comprising from about 5 to about 100 wt. % of (nano)composite anode powders (as a fraction of all active materials), wherein such (nano)composite anode powders exhibit moderately high volume changes during the first charge-discharge cycle, moderate volume changes during the subsequent charge-discharge cycles, an average size (e.g., average diameter) in the range from about 0.2 to about 40 microns and specific surface area in the range from about 0.5 to about 50 m²/g and, in the case of Si-comprising (nano)composite anode powders, specific reversible capacities in the range from about 800 to about 3000 mAh/g (when normalized by the mass of the composite anode particles only) or with the corresponding anode specific reversible capacities being in the range from about 400 to about 2800 mAh/g (when normalized by the total mass of all the active electrode particles, conductive additives and binders). In some designs (e.g., depending on cell chemistry, loading, operating conditions and/or other factors), suitable branched esters or related compounds (or their mixtures) may be added at the additive level (from about 0.1 to about 5-10 wt. %) or as main solvent/co-solvent level (from about 5-10 to about 92 wt. %) for attaining substantial benefits.

Examples of such benefits may include one or more of the following: (i) improving high-temperature storage stability (e.g., retaining higher reversible capacity after about 1 h to about 10 years of storage at elevated temperatures (e.g., about 40-80° C.) at high state of charge (SOC) (e.g., about 70-100% SOC) or reducing gas generation after storage or cycling at elevated temperatures); (ii) reducing gas generation during storage or cycling at room or low temperatures; (iii) reducing or minimizing cell swelling (or built-in stresses in cells) at the end of life (e.g., after about 20-80% of the initial capacity retention); (iv) improving cycling stability when used at different temperature conditions; (v) reducing or minimizing impedance growth during cycling, (vi) reducing or minimizing formation of undesirable (harmful) by-products during battery cell operation, among others.

Some of such benefits may stem from the formation of more favorable or more robust cathode/electrolyte interphase (CEI) film that may, for example, help to reduce or minimize electrolyte oxidation on the cathode with the formation of gaseous species or help to reduce or minimize cathode dissolution or other unfavorable/undesirable interactions between the cathode and liquid electrolyte in a Li or Li-ion battery. In some designs (for example, in case of using some of the suitable branched esters, such as ethyl isobutyrate, methyl isobutyrate, ethyl trimethylacetate, methyl trimethylacetate, ethyl isovalerate, methyl isovalerate, methyl 2-methylbutyrate, ethyl 2-methylbutyrate, methyl 2-fluoro-2-methylpropionate, methyl 2-fluoropropionate, methyl 2-methyl-3-cyanopropionate and others), a more robust CEI film formation may be related to having a stronger adhesion to the cathode surface (e.g., by means of interaction between F or CN of the ester with cathode surface). Some of such benefits may also stem from the formation of more favorable or more robust solid electrolyte interphase (SEI) film on the anode (or, for example, from the helping to maintain a more stable anode SEI). In some designs, improved SEI stability may be related to the dramatically reduced diffusion of suitable branched esters and related compounds through the SEI, which may prevent or greatly reduces or minimizes their reduction as well as other electrolyte components on the anode surface, particularly at elevated temperatures. In some designs, improved CEI and SEI stabilities may be related to the structure of the Li-ion solvation shell, which may be advantageously comprised of certain electrolyte components, while comprise no or minimum amounts of other less desirable components (e.g., gas-inducing components, etc.). In some designs, improved SEI stability may be related to the reduced tendency to form gaseous species upon electrolyte electrochemical or chemical reduction. In some designs, improved SEI stability may be related to the improved ability to form more elastically or plastically deformable (in the electrolyte) SEI or, for example, less resistive SEI. Such improved SEI stability or properties may, for example, help reduce or minimize electrolyte reduction on the anode (with the associated undesirable irreversible losses of cyclable Li or with the undesirable formation of gaseous species or undesirable anode swelling, etc.) or may help to reduce or minimize anode dissolution or other unfavorable/undesirable interactions between the anode and liquid electrolyte in a Li or Li-ion battery, which may lead to impedance growth or gas generation or other undesirable processes or performance degradations in cells. Some of the undesirable processes may stem from the reduction in elastic modulus of the electrode binders upon exposure of electrodes to electrolytes during cell formation or cell operation (cycling). In some designs, it may be preferable to select an electrolyte composition based on suitable branched ester co-solvents where the binder in at least one of the electrodes does not reduce its elastic modulus by over about 30 vol. % (e.g., more preferably in some designs, by over about 10 vol. %) when exposed to electrolyte.

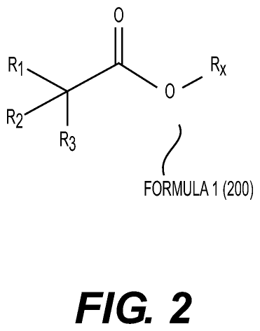

FIG. 2 illustrates examples of suitable branched esters (electrolyte solvents/co-solvents) having a general Formula 1, where R₁, R₂, and R₃ may be independently selected (e.g., as used herein, “independently selected” means that R₁, R₂, and R₃ can be the same or different, and the selection(s) of the material(s) for R₁, R₂, and R₃ can be made separately) from: H, C₁₋₅ alkyl, halogen, cyano, sulfonyl, alkoxy, trifluoroalkyl, difluoroalkyl, monofluoroalkyl, cycloalkyl, aryl, and aryloxy; and where Rₓ is C₁₋₅ alkyl. In some designs, R₁+R₂, R₁+R₃, or R₂+R₃ may form C₄₋₆ aliphatic cycle or C₄₋₆ aromatic heterocycle.

In some designs, it may be advantageous of the branched esters of Formula 1 to comprise from about 3 to about 10 carbon atoms per molecule (in some designs, from about 4 to about 8).

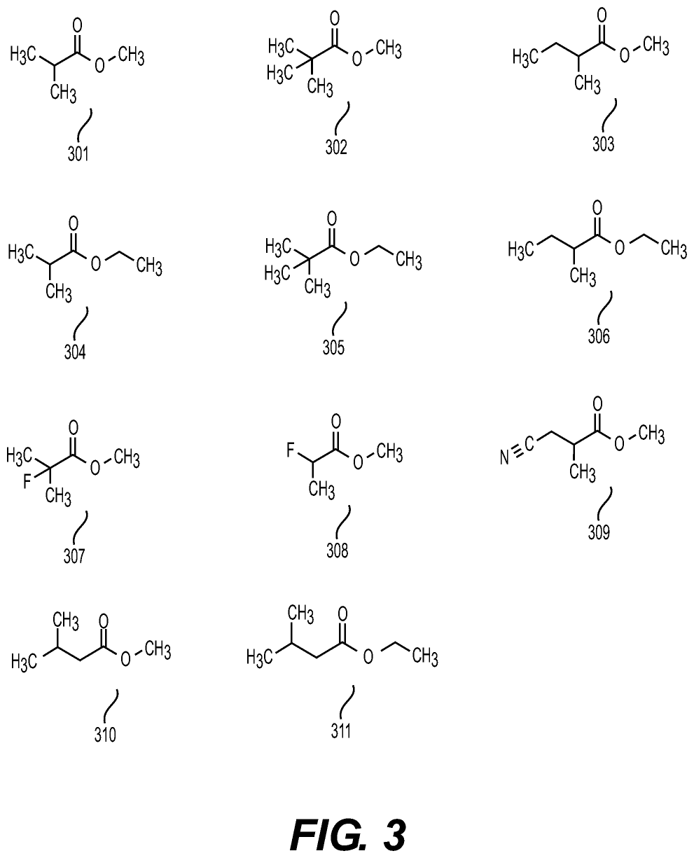

FIG. 3 illustrates some specific examples of the branched ester of FIG. 2: methyl 2-methylpropionate (301), methyl 2,2-dimethylpropionate (also called methyl isobutyrate) (302), methyl 2-methylbutyrate (303), ethyl 2-methylpropionate (also called ethyl isobutyrate) (304), ethyl 2,2-dimethylpropionate (305), ethyl 2-methylbutyrate (306), methyl 2-fluoro-2-methylpropionate (307), methyl 2-fluoropropionate (308), methyl 2-methyl-3-cyanopropionate (309), methyl isovalerate (310), ethyl isovalerate (311).

In some designs, suitable branched esters (including but not limited to those illustrated as the examples in FIGS. 2 and 3) or related compounds may offer greatly reduced (e.g., compared to linear esters or certain carbonates or other commonly used electrolyte solvents/co-solvents) H abstraction activity (e.g., in the alpha-position to carboxy group).

In some designs, suitable branched esters (including but not limited to those illustrated as the examples in FIGS. 2 and 3) or related compounds may offer greatly reduced gassing of electrolyte on the anode surface (including, but not limited to the case of Li plating on the anode surface). In some designs, esters with two or three alkyl groups in the alpha position to carboxyl group of the ester may offer particularly improved performance.

In some designs, suitable branched esters including but not limited to those illustrated as the examples in FIGS. 2 and 3) or related compounds may offer greatly reduced transition metal dissolution from the surface of the cathode. Such examples of transition metal include Co species, Mn species, and Ni species. In one embodiment, the formation of the CEI on the cathode interface, which is caused by the presence of the branched esters in the electrolyte formulations, may be beneficial to the cycle life performance by decreasing the loss of active materials on the cathode. In another embodiment, the formation of the CEI on the cathode interface, which is caused by the presence of the branched esters in the electrolyte formulations, may be beneficial to the reduced outgassing at elevated temperatures, which could be catalyzed by the transition metal ion (such as Co, Mn, Ni ions).

In some designs, suitable branched esters (including but not limited to those illustrated as the examples in FIGS. 2 and 3) or related compounds may mitigate parasitic (highly undesirable) degradation of common SEI “builders” (such as fluoroethylene carbonate, FEC, vinylene carbonate, VC, ethylene carbonate, EC, among others) present in the electrolyte. In some designs, esters with two or three alkyl groups in the alpha position to carboxyl group of the ester may offer particularly improved performance.

In some designs, suitable branched esters (including but not limited to those illustrated as the examples in FIGS. 2 and 3) or related compounds may reduce or completely avoid the undesirable formation of enol form of the corresponding ester (or reduce the formation of tautomeric enol form) (e.g., by shifting the equilibrium towards the ester). In some designs, by reducing or avoiding the enol presence in the electrolyte, the parasitic degradation of Li salt(s) (e.g., lithium hexafluorophosphate (LiPF₆)) or other electrolyte components by, for example, alcoholysis could be greatly reduced or minimized. Similarly, in some designs, formation of hydrofluoric acid (HF) or other undesirable by-products of, e.g., LiPF₆ alcoholysis, could be greatly reduced or minimized.

In some designs, some suitable branched esters or suitable related compounds may be preferably used as electrolyte additives (in smaller quantities, for example, in the range from about 0.1 to about 10 wt. %; in some designs, from about 0.1 wt. % to about 0.5 wt. %; in other designs, from about 0.5 wt. % to about 1 wt. %; in other designs, from about 1 wt. % to about 2 wt. %; in other designs, from about 2 wt. % to about 4 wt. %; in other designs, from about 4 wt. % to about 10 wt. %).

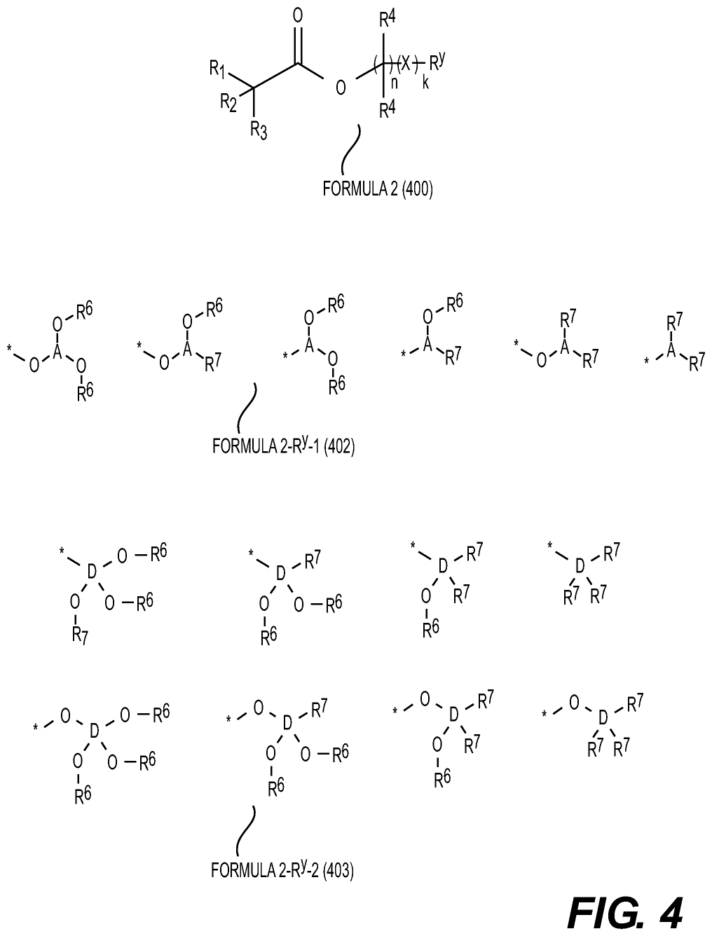

FIG. 4 illustrates examples of suitable branched ester additives (minor electrolyte co-solvents) having a general Formula 2, where (i) R¹, R², and R³ are independently selected (e.g., as used herein, “independently selected” means that R₁, R₂, and R₃ can be the same or different, and the selection(s) of the material(s) for R₁, R₂, and R₃ can be made separately) from the group of: H, C₁₋₅ alkyl, halogen, cyano, cyano-substituted alkyl, sulfonyl, sulfonyl-substituted alkyl, alkoxy, alkoxyalkyl, trifluoroalkyl, difluoroalkyl, monofluoroalkyl, cycloalkyl, aryl, aryloxy; and where R₁+R₂, R₁+R³, or R²+R³ may independently form C₄₋₆ aliphatic cycle, or C₄₋₆ aromatic heterocycle; (ii) where, R⁴ may be selected from: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, aryloxy; (iii) where n may be in the range from 0 to 5; (iv) where X may be selected from: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl, where p is the range of 0 to 5, and where R⁵ may be selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, monofluoroalkyl; (v) where k may be in the range from 0 to 5; (vi) where R^{y} may be selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkylsulfonyl-C₁₋₅alkyl, N—C₁₋₅alkylsulfonyl-aryl, a 5-8 membered saturated or non-saturated S-containing ring wherein S-group may be represented by —S(═O)— or —S(═O)₂—, a 5-8 membered saturated or non-saturated P-containing ring wherein P-group can be represented by —P(═O)—, —(P(═O)H)—, —(P(═O)C₁₋₃alkyl)-, —(P(═O)OH)— or —(P(═O)OC₁₋₃alkyl)-, diC₁₋₅ alkyl phosphonite, diC₁₋₅ alkyl phosphonate, (C₁₋₅alkoxy)(C₁₋₅alkyl)phosphane, C₁₋₅alkyl C₁₋₅alkylphosphinate, diC₁₋₅alkylphosphane, C₁₋₅ alkyl C₁₋₅ alkylphosphinate, diC₁₋₅ alkyl phosphine oxide, diC₁₋₅alkylphosphite, diC₁₋₅ alkylphosphate, C₁₋₅ alkyl C₁₋₅ alkylphosphonite, C₁₋₅ alkyl C₁₋₅alkylphosphonate, (C₁₋₅alkoxy)(diC₁₋₅alkyl)phosphane, diC₁₋₅alkylphosphinate, phosphazene, cyclic phospharane, acyclic phosphorane, 1,3-dioxolan-2-one, 1,3-dioxol-2-one, and (vii) where R^{y} may be selected from Formula 2-R^{y}-1 (402), where A in (402) may be selected from: aluminum (Al) or boron (B), and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and R⁷ may be selected from the group of: C₁₋₅ alkyl, halogen, cyano, cyano-substituted alkyl, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; or (viii) where R^{y} may be selected from Formula 2-R^{y}-2 (403), where D may be selected from the group of: silicon (Si) or tin (Sn), and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and where R⁷ may be selected from the group of: C₁₋₅ alkyl, halogen, cyano, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; and where in the definition of R^{y} each heterocyclyl may be optionally substituted with one C₁₋₃ alkyl group, fluoro, cyano, trifluoromethyl, chloro, isocyanate, isothiocyanate, P(O-alkyl)₂, P(═O)(O-alkyl)₂, azido, and wherein one CH₂ group of said heterocyclyl of R^{y} may be replaced by a carbonyl group.

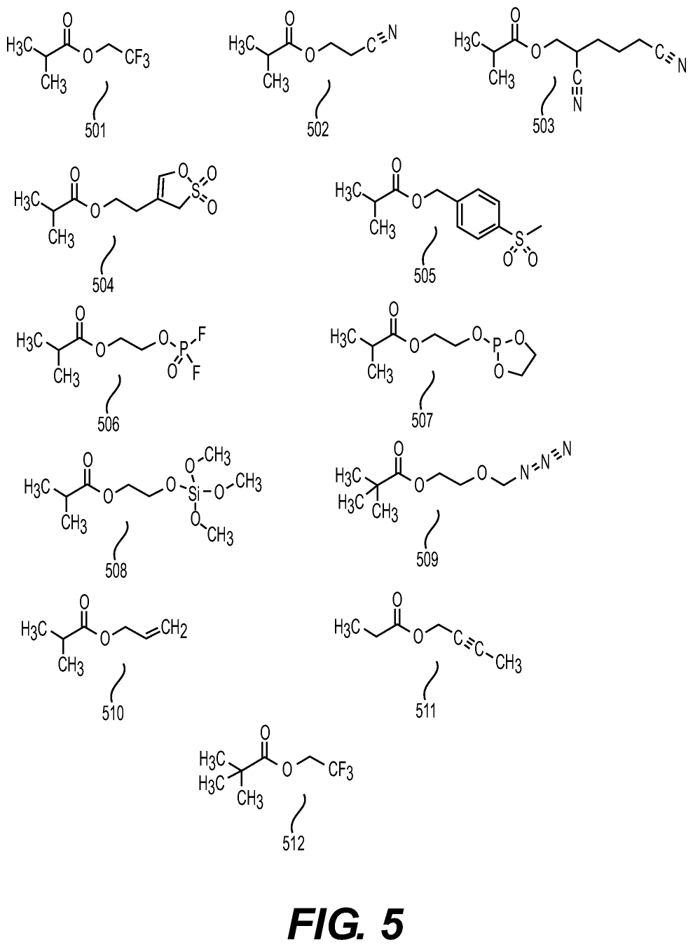

FIG. 5 illustrates some specific examples of the branched esters of FIG. 4: 2,2,2-trifluoroethyl isobutyrate (501), 2-cyanoethyl isobutyrate (502), 2,5-dicyanopentyl isobutyrate (503), 2-(2,2-dioxido-3H-1,2-oxathiol-4-yl)ethyl isobutyrate (504), 4-(methyl sulfonyl)benzyl isobutyrate (505), 2-((difluorophosphoryl)oxy)ethyl isobutyrate (506), 2-((1,3,2-dioxaphospholan-2-yl)oxy)ethyl isobutyrate (507), 2-((trimethoxysilyl)oxy)ethyl isobutyrate (508), 2-(azidomethoxy)ethyl pivalate (509), allyl isobutyrate (510), but-2-yn-1-yl propionate (511), 2,2,2-trifluoroethyl trimethylacetate (512).

In one or more embodiments of the present disclosure, favorable electrolyte composition for the described and other Li or Li-ion batteries may include a small fraction (from about 0.1 to about 10 wt. %, as a fraction of all solvents in the electrolyte; in some designs, from about 0.1 wt. % to about 0.5 wt. %; in other designs, from about 0.5 wt. % to about 1 wt. %; in other designs, from about 1 wt. % to about 2 wt. %; in other designs, from about 2 wt. % to about 4 wt. %; in other designs, from about 4 wt. % to about 10 wt. %) of suitable electrolyte additives, including those disclosed herein.

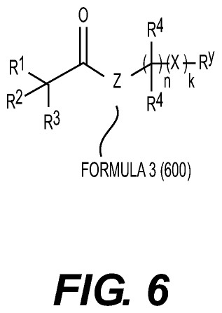

FIG. 6 illustrates examples of suitable electrolyte additives of a general Formula 3 (600), where (i) R¹, R², and R³ may be independently selected (e.g., as used herein, “independently selected” means that R₁, R₂, and R₃ can be the same or different, and the selection(s) of the material(s) for R₁, R₂, and R₃ can be made separately) from the group of: H, C₁₋₅ alkyl, halogen, cyano, cyano-substituted alkyl, sulfonyl, sulfonyl-substituted alkyl, alkoxy, alkoxyalkyl, trifluoroalkyl, difluoroalkyl, monofluoroalkyl, cycloalkyl, aryl, aryloxy; and where, R₁+R₂, R₁+R³, or R²+R³ may form C₄₋₆ aliphatic cycle, or C₄₋₆ aromatic heterocycle; where (ii) Y may be O or S (or Se in some designs); where (iii) Z may be O, S, Se (in some designs) or NH, but where Y and Z cannot simultaneously represent (be) O; where (iii) R⁴ may be selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, aryloxy; where (iv) n may range from 0 to 5; where (v) X may be selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl, where p is in the range of 0 to 5, and where R⁵ may be selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, monofluoroalkyl; where (vi) k may be in the range from 0 to 5; where (vii) R^{y} may be selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkylsulfonyl-C₁₋₅alkyl, N—C₁₋₅alkylsulfonyl-aryl, a 5-8 membered saturated or non-saturated S-containing ring wherein S-group may be represented by —S(═O)— or —S(═O)₂—, a 5-8 membered saturated or non-saturated P-containing ring wherein P-group can be represented by —P(═O)—, —(P(═O)H)—, —(P(═O)C₁₋₃alkyl)-, —(P(═O)OH)— or —(P(═O)OC₁₋₃alkyl)-, diC₁₋₅ alkyl phosphonite, diC₁₋₅ alkyl phosphonate, (C₁₋₅alkoxy)(C₁₋₅alkyl)phosphane, C₁₋₅ alkyl C₁₋₅ alkylphosphinate, diC₁₋₅ alkylphosphane, C₁₋₅ alkyl C₁₋₅alkylphosphinate, diC₁₋₅ alkyl phosphine oxide, diC₁₋₅ alkylphosphite, diC₁₋₅alkylphosphate, C₁₋₅ alkyl C₁₋₅ alkylphosphonite, C₁₋₅ alkyl C₁₋₅ alkylphosphonate, (C₁₋₅alkoxy)(diC₁₋₅alkyl)phosphane, diC₁₋₅ alkylphosphinate, phosphazene, cyclic phospharane, acyclic phosphorane, 1,3-dioxolan-2-one, 1,3-dioxol-2-one or where (viii) R^{y} may be selected from one of the Formula 2-R^{y}-1 compositions (402) (FIG. 4), where A may be selected from the group of: Al or B, and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and R⁷ may be selected from the group of: C₁₋₅ alkyl, halogen, cyano, cyano-substituted alkyl, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; or where R^{y} may be defined as one of the Formula 2-R^{y}-2 compositions (403) (FIG. 4), where D may be Si or Sn, and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and where R⁷ may be selected from the group of: C₁₋₅ alkyl, halogen, cyano, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; and where in R^{y} each heterocyclyl may be optionally substituted with one of the: C₁₋₃ alkyl group, fluoro, cyano, trifluoromethyl, chloro, isocyanate, isothiocyanate, P(O-alkyl)₂, P(═O)(O-alkyl)₂, or azido, and where one CH₂ group of said heterocyclyl of R^{y} may be replaced by a carbonyl group.

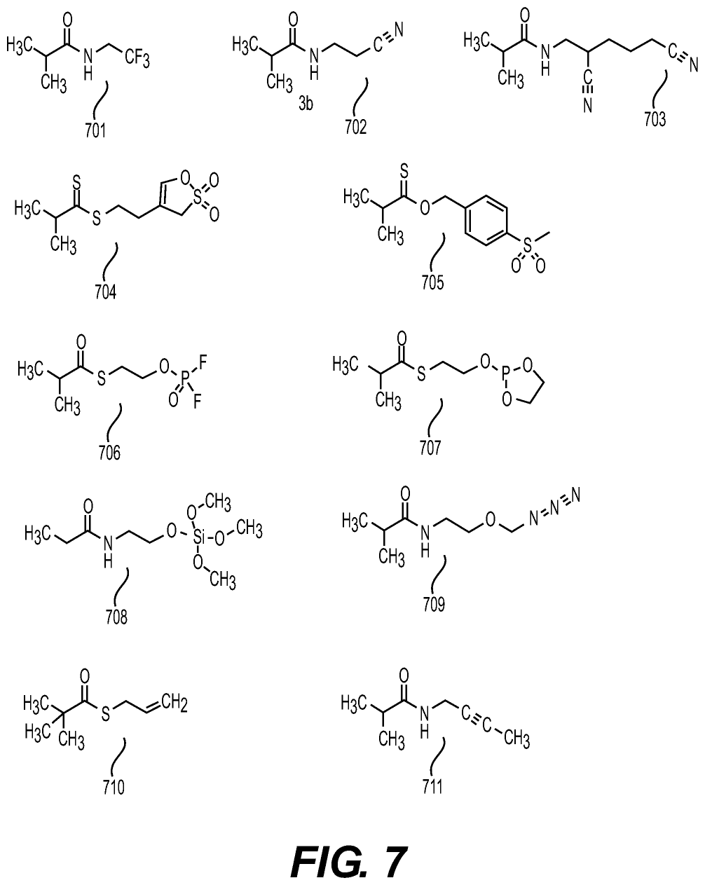

FIG. 7 illustrates some specific examples of suitable electrolyte additives of FIG. 6: N-(2,2,2-trifluoroethyl)isobutyramide (701), N-(2-cyanoethyl)isobutyramide (702), N-(2,5-dicyanopentyl)isobutyramide (703), 2-(2,2-dioxido-3H-1,2-oxathiol-4-yl)ethyl 2-methylpropanedithioate (704), O-(4-(methyl sulfonyl)benzyl) 2-methylpropanethioate (705), S-(2-((difluorophosphoryl)oxy)ethyl) 2-methylpropanethioate (706), S-(2-((1,3,2-dioxaphospholan-2-yl)oxy)ethyl) 2-methylpropanethioate (707), trimethyl (2-propionamidoethyl) silicate (708), N-(2-(azidomethoxy)ethyl)isobutyramide (709), S-allyl 2,2-dimethylpropanethioate (710), N-(but-2-yn-1-yl)isobutyramide (711).

In some designs, it may be advantageous for the suitable electrolyte additives of the general Formula 3 (600) (FIG. 6), including those illustrated by FIG. 7 (e.g., 701, 702, 703, 704, 705, 706, 707, 708, 709, 710, 711) to exhibit a low melting point in the range from about +40 to about −100° C. (in some designs, the melting point may preferably be below about 0° C.; in other designs, the melting point may preferably be below about minus (−) 20° C.; in other designs, the melting point may preferably be below about −40° C.; and in yet other designs, the melting point may preferably be below about −60° C.).

In some designs, it may be advantageous for the suitable electrolyte additives of a general Formula 3 (600) (FIG. 6), including those illustrated by FIG. 7 (e.g., 701, 702, 703, 704, 705, 706, 707, 708, 709, 710, 711) to exhibit a boiling point in the range from about +10 to about +250° C. In some designs, the boiling point may preferably be above +20° C. (note that in other designs, the boiling point may preferably be above about 40° C.; in other designs, the boiling point may preferably be above about 60° C.; in other designs, the boiling point may preferably be above about 80° C.; in other designs, the boiling point may preferably be above about 100° C.; in yet other designs, the boiling point may preferably be above about 120° C.; in other designs, the boiling point may preferably be above about 150° C.; in yet other designs, the boiling point may preferably be above about 180° C.).

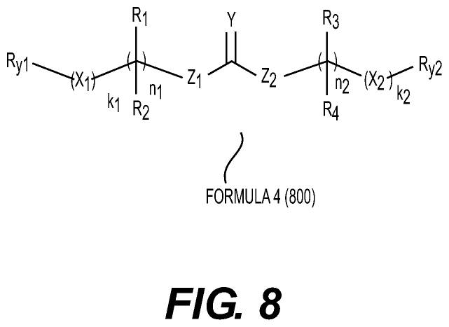

FIG. 8 illustrates other examples of suitable electrolyte additives of a general Formula 4 (800), where (i) Y may be O or S (or Se in some designs); where (ii) Z₁ and Z₂ may be O, S, Se (in some designs) or NH; where (iii) R₁, R₂, R₃, and R₄ may be independently selected (e.g., as used herein, “independently selected” means that R₁, R₂, R₃, and R₄ can be the same or different, and the selection(s) of the material(s) for R₁, R₂, R₃, and R₄ can be made separately) from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, aryloxy; where (iv) n₁ and n₂ may range from 0 to 5; where (v) X₁ and X₂ may be independently selected (e.g., as used herein, “independently selected” means that X₁ and X₂ can be the same or different, and the selection(s) of the material(s) for X₁ and X₂ can be made separately) from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl, where p is in the range of 0 to 5, and where R⁵ may be selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, monofluoroalkyl; where (vi) k₁ and k₂ may be in the range from 0 to 5; where (vii) R^{y} may be selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkylsulfonyl-C₁₋₅alkyl, N—C₁₋₅alkylsulfonyl-aryl, a 5-8 membered saturated or non-saturated S-containing ring wherein S-group can be represented by —S(═O)— or —S(═O)₂—, a 5-8 membered saturated or non-saturated P-containing ring wherein P-group can be represented by —P(═O)—, —(P(═O)H)—, —(P(═O)C₁₋₃alkyl)-, —(P(═O)OH)— or —(P(═O)OC₁₋₃alkyl)-, diC₁₋₅alkyl phosphonite, diC₁₋₅alkyl phosphonate, (C₁₋₅alkoxy)(C₁₋₅alkyl)phosphane, C₁₋₅alkyl C₁₋₅alkylphosphinate, diC₁₋₅alkylphosphane, C₁₋₅alkyl C₁₋₅alkylphosphinate, diC₁₋₅alkyl phosphine oxide, diC₁₋₅alkylphosphite, diC₁₋₅alkylphosphate, C₁₋₅alkyl C₁₋₅alkylphosphonite, C₁₋₅alkyl C₁₋₅alkylphosphonate, (C₁₋₅alkoxy)(diC₁₋₅alkyl)phosphane, diC₁₋₅alkylphosphinate, phosphazene, cyclic phospharane, acyclic phosphorane, 1,3-dioxolan-2-one, 1,3-dioxol-2-one or where (viii) Ry₁ and Ry₂ may be selected from one of the Formula 2-R^{y}-1 compositions (402) (FIG. 4), where A may be selected from the group of: Al or B, and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and R⁷ is selected from the group of: C₁₋₅ alkyl, halogen, cyano, cyano-substituted alkyl, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; or where Ry₁ and Ry₂ may be defined as one of the Formula 2-R^{y}-2 compositions (403) (FIG. 4), where D may be Si or Sn, and where R⁶ may be selected from the group of: C₁₋₅ alkyl, halogen, azido, cyano, sulfonyl, alkoxy, trifluoroalkyl, difluoroalkyl, monofluoroalkyl, cycloalkyl, aryl, aryloxy, and where R⁷ may be selected from the group of: C₁₋₅ alkyl, halogen, cyano, sulfonyl, alkoxy, trifluoroalkyl, difluoroalkyl, monofluoroalkyl, cycloalkyl, aryl, aryloxy, and where R⁶+R⁷ may form C₄₋₆ aliphatic cycle or C₄₋₆ aromatic heterocycle; and where in R^{y} each heterocyclyl may be optionally substituted with one of the: C₁₋₃ alkyl group, fluoro, cyano, trifluoromethyl, chloro, isocyanate, isothiocyanate, P(O-alkyl)₂, P(═O)(O-alkyl)₂, or azido, and where one CH₂ group of said heterocyclyl of Ry₁ and Ry₂ may be replaced by a carbonyl group.

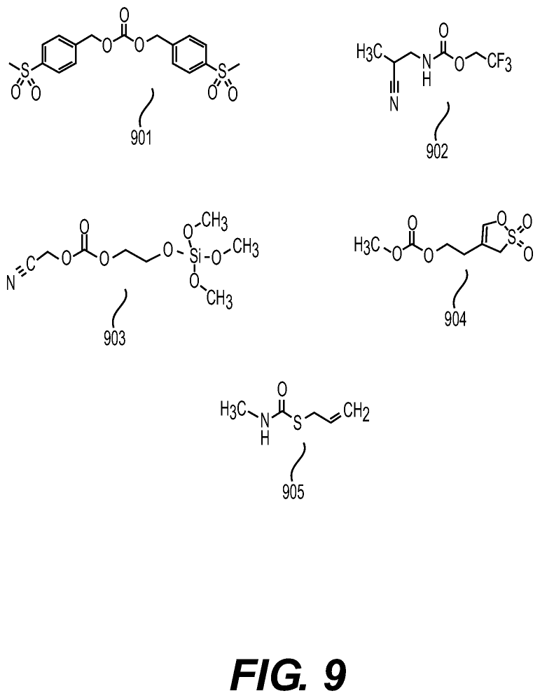

FIG. 9 illustrates some specific examples of the suitable electrolyte additives of FIG. 8: bis(4-(methylsulfonyl)benzyl) carbonate (901), 2,2,2-trifluoroethyl (2-cyanopropyl)carbamate (902), cyanomethyl (2-((trimethoxysilyl)oxy)ethyl) carbonate (903), 2-(2,2-dioxido-3H-1,2-oxathiol-4-yl)ethyl methyl carbonate (904), S-allyl methylcarbamothioate (905).

In one or more embodiments of the present disclosure, suitable electrolyte co-solvents of the Formula 1 (200), Formula 2 (400), Formula 3 (600) or other suitable compositions may preferably exhibit certain structural characteristics seen in the ¹H Nuclear Magnetic Resonance (NMR) spectroscopy as methine (CH) chemical shift in the alpha position to the ester carboxyl (—C(O)O—) group in the ppm (parts per million) range from about 2.0 to about 3.0 ppm. In other designs, the ppm range of the methine (CH) group may be affected by the electronegativity of the neighboring groups and may preferably be from about 1.5 to about 3.5 ppm.

In one or more embodiments of the present disclosure, suitable co-solvents (or solvent additives) of the Formula 1 (200), Formula 2 (400), Formula 3 (600) or other suitable compositions may preferably exhibit certain structural characteristics seen in the ¹³C NMR spectroscopy as methine (CH) chemical shift in the alpha position to the ester carboxyl (—C(O)O—) group in the ppm range from about 20 to about 50 ppm. In other designs, the ppm range of the methine (CH) chemical shift may be affected by the electronegativity of neighboring groups and may preferably range from about 10 to about 70 ppm.

In one or more embodiments of the present disclosure, suitable co-solvents (or solvent additives) of the Formula 1 (200), Formula 2 (400), Formula 3 (600) or other suitable compositions may preferably exhibit structural characteristics seen in the ¹H NMR spectroscopy as the absence of the methylene (CH₂) or methine (CH) chemical shifts in the alpha position to the ester carboxyl (—C(O)O—) group.

In one or more embodiments of the present disclosure, suitable co-solvents (or solvent additives) of the Formula 1 (200), Formula 2 (400), Formula 3 (600) or other suitable compositions may preferably exhibit structural characteristics seen in the ¹³C NMR spectroscopy as quaternary (C) chemical shift in the alpha position to the ester carboxyl (—C(O)O—) group in the ppm range from about 30 to about 50 ppm. In other designs, the ppm range of the quaternary carbon (C) chemical shift may be affected by the electronegativity of neighboring groups and may preferably range from about 20 to about 60 ppm.

In some designs, it may be advantageous for suitable electrolyte additives of the general Formula 4 (800) (FIG. 8), including those illustrated by FIG. 9 (e.g., 901, 902, 903, 904, 905) to exhibit a low melting point in the range from about +40 to about −100° C. (in some designs, the melting point may preferably be below about 0° C.; in other designs, the melting point may preferably be below about minus (−) 20° C.; in other designs, the melting point may preferably be below about −40° C.; and in yet other designs, the melting point may preferably be below about −60° C.).

In some designs, it may be advantageous for suitable electrolyte additives of the general Formula 4 (800) (FIG. 8), including those illustrated by FIG. 9 (e.g., 901, 902, 903, 904, 905) to exhibit a boiling point in the range from about +10 to about +250° C. In some designs, the boiling point may preferably be above +20° C. (note that in other designs, the boiling point may preferably be above about 40° C.; in other designs, the boiling point may preferably be above about 60° C.; in other designs, the boiling point may preferably be above about 80° C.; in other designs, the boiling point may preferably be above about 100° C.; in yet other designs, the boiling point may preferably be above about 120° C.; in other designs, the boiling point may preferably be above about 150° C.; in yet other designs, the boiling point may preferably be above about 180° C.).

In the context of one or more embodiments of the present disclosure, the types of enhancement(s) in Li and Li-ion battery performance characteristics and even the mechanisms for such enhancement(s) may be the same or similar for the electrolytes comprising co-solvents and/or additives described by the Formula 1 (200), Formula 2 (400), Formula 3 (600) and Formula 4 (800).

In some designs, in the context of one or more embodiments of the present disclosure, it may be beneficial to utilize a combination of two, three or more electrolyte co-solvents (at suitable levels or weight fractions) of the Formula 1 (200), Formula 2 (400), Formula 3 (600) and Formula 4 (800) in the electrolyte for the discussed Li and Li-ion batteries.

In some designs, in the context of one or more embodiments of the present disclosure, the suitable weight fraction of the total of all (e.g., one, two, three or more) electrolyte co-solvents of the Formula 1 (200), Formula 2 (400), Formula 3 (600) and Formula 4 (800) in the electrolyte may range from about 0.1 to about 92-94 wt. %, as a fraction of all solvents in the electrolyte. In some designs (depending on the anode and cathode chemistry and maximum cell voltage), the fraction of suitable electrolyte co-solvents of the Formula 1 (200), Formula 2 (400), Formula 3 (600) and Formula 4 (800) may range from about 0.1 to about 5-10 wt. %; in other designs, from about 5-10 to about 30 wt. %; in other designs, from about 30 to about 40 wt. %; in other designs, from about 40 to about 50 wt. %; in other designs, from about 50 to about 60 wt. %; in yet other designs, from about 60 to about 92-94 wt. %.

In some designs, in the context of one or more embodiments of the present disclosure, it may be beneficial to utilize one, two, three or more electrolyte co-solvents (at suitable levels or weight fractions) of the Formula 1 (200), Formula 2 (400), Formula 3 (600) and/or Formula 4 (800) in the electrolyte together with a suitable fraction of various suitable cyclic or linear esters (e.g., γ-valerolactone, γ-methylene-γ-butyrolactone, γ-hexalactone, α-angelica lactone, α-methylene-γ-butyrolactone, ε-caprolactone, 5,6-dihydro-2H-pyran-2-one, γ-butyrolactone, δ-hexalactone, α-methyl-γ-butyrolactone, phthalide, γ-caprolactone, ethyl propionate, propyl acetate, methyl formate, butyl formate, ethyl acetate, butyl acetate, amyl formate, methyl caproate, ethyl valerate, propyl butyrate, butyl propionate, amyl acetate, hexyl formate, propyl propionate, methyl propionate, ethyl propionate, methyl valerate, methyl butyrate, ethyl butyrate, butyl valerate, butyl butyrate, propyl propionate, etc.) and other suitable solvents as co-solvents in the electrolyte composition. In some designs, some of the benefits of including cyclic or linear esters may include one or more of the following: improved electrolyte ionic conductivity, reduced electrolyte viscosity, improved cycle stability of cells, reduced cell resistance, improved calendar life, improved low-temperature performance, among others. In some designs, two or more linear esters that form eutectic mixture may be advantageously utilized. In some designs, two or more cyclic esters that form eutectic mixture may be advantageously utilized. In some designs, the fraction of linear and cyclic esters in the electrolyte (that additionally comprises suitable branched esters or other suitable co-solvents) may range from about 0.1 to about 60.0 wt. % (e.g., in some designs, from about 0.1 to about 5.0 wt. %; in some designs, from about 5 to about 10 wt. %; in some designs, from about 10 to about 15 wt. %; in some designs, from about 15 to about 20 wt. %; in some designs, from about 20 to about 25 wt. %; in some designs, from about 25 to about 60 wt. %). In some designs (depending on the anode and cathode chemistry, maximum cell voltage, cell operating conditions, etc.), the total fraction of all esters (branched, linear and cyclic) in the electrolyte may range from about 0.2 to about 98 wt. % (as a fraction of all electrolyte solvents).

In some designs, in the context of one or more embodiments of the present disclosure, it may be beneficial to utilize one, two, three or more electrolyte co-solvents (at suitable levels or weight fractions) of the Formula 1 (200), Formula 2 (400), Formula 3 (600) and/or Formula 4 (800) in the electrolyte together with the suitable fraction of various suitable cyclic or linear or complex carbonates (e.g., ethylene carbonate (EC), propylene carbonate (PC), vinylene carbonate (VC), vinyl ethylene carbonate (VEC), fluoroethylene carbonate (FEC), 3,3,3-fluoroethyl methyl carbonate (FEMC), diethyl carbonate (DEC), dimethyl carbonate (DMC), among others), among other electrolyte components. In some designs, EC, PC, VC, VEC, FEC, FEMC may be utilized to improve stability of the anode SEI. In some cell designs (e.g., for cells comprising certain anodes, e.g., that comprise little or no graphite or certain cathodes), though, electrolyte compositions free from PC or free from EC may also be beneficial (e.g., to reduce charge transfer resistance or improve rate performance or improve cycle stability or reduce gassing, etc.). In some cell designs, though, electrolyte compositions free from linear carbonates (e.g., DEC, DMC, ethyl methyl carbonate (EMC), etc.) may also be beneficial (e.g., to reduce charge transfer resistance or improve rate performance or improve cycle stability or reduce gassing, or improve low temperature performance, etc.). In some designs, (4R,5 S)-4,5-difluoro-1,3-dixolan-2-one (DiFEC), methylene-ethylene carbonate (MEC), prop-1-ene-1,3-sultone (PES), ethylene sulfate (or 1,3,2-dioxathiolane-2,2-dioxide (DTD)), methylene-methane disulfonate (MMDS), tris-(trimethyl-silyl) phosphite (TTPi), 1H-imidazol-1-yl-(morpholino)methanone (MUI), succinic anhydride (SA), 1,1,2,2-tetrafluoroethyl-2′,2′,2′-trifluoroethyl ether (HFE), and other known CEI (and SEI) additives and their various combinations may be advantageously used as well. In some designs, it may be advantageous for the weight fraction of all suitable carbonates (in addition to all other suitable electrolyte solvent additives) in such electrolyte compositions to range from about 5 wt. % to about 75 wt. % (as a fraction of all the solvents in the electrolyte). In some designs, such a fraction may range from about 5 wt. % to about 15 wt. %; in other designs, such a fraction may range from about 15 wt. % to about 25 wt. %; in other designs, such a fraction may range from about 25 wt. % to about 35 wt. %; in other designs, such a fraction may range from about 35 wt. % to about 45 wt. %; in other designs, such a fraction may range from about 45 wt. % to about 55 wt. %; yet in other designs, such a fraction may range from about 55 wt. % to about 65 wt. %; yet in other designs, such a fraction may range from about 65 wt. % to about 75 wt. %.

In some designs, in the context of one or more embodiments of the present disclosure, it may be beneficial to utilize one, two, three or more electrolyte co-solvents (at suitable levels or weight fractions) of the Formula 1 (200), Formula 2 (400), Formula 3 (600) and/or Formula 4 (800) in the electrolyte together with the suitable fraction of various suitable branched cyclic carbonates (e.g., 4-ethyl-1,3-dioxolan-2-one, 4, dimethyl-1,3-dioxolan-2-one, 4,4-dimethyl-1,3-dioxolan-2-one, 4-propyl-1,3-dioxolan-2-one, among others) or branched linear carbonates (e.g., ethyl isopropyl carbonate, ethyl isobutyl carbonate, tert-butyl ethyl carbonate, among others), among other electrolyte components. In some designs, it may be advantageous for the weight fraction of all branched cyclic carbonates and all branched linear carbonates in such electrolyte compositions to range from about 2 wt. % to about 30 wt. % (as a fraction of all the solvents in the electrolyte).

In some designs, in the context of one or more embodiments of the present disclosure, it may be beneficial (e.g., for improved stability or increased maximum cell voltage or performance at elevated or room or low temperatures) to utilize one, two, three or more electrolyte co-solvents (at suitable levels or weight fractions) of the Formula 1 (200), Formula 2 (400), Formula 3 (600) and/or Formula 4 (800) in the electrolyte together with a suitable fraction (e.g., from about 0.05 wt. % to about 60 wt. %) of various (other, not belonging to Formulas 1-4) sulfur (S)-comprising co-solvents (e.g., cyclic sulfones such as tetramethylene sulfone (also called sulfolane), 1,3,2-dioxathiolane-2,2-dioxide (DTD), methylene methanedisulfonate, tris(trimethylsilyl) phosphite, trimethylene sulfate, terthiophene, sulfonyldiimidazole, ethylene sulfite, phenyl vinyl sulfone and others; cyclic sulfonic esters such as propane sultone, propene sultone, phenyl vinyl sultone, and others; linear sulfonic esters, linear sulfones such as dimethyl sulfone, ethylmethyl sulfone and others; sulfoxides, etc.), among other suitable co-solvents in the electrolyte. In some designs, such a fraction of sulfur-containing solvents may range from about 0.05 wt. % to about 0.2 wt. %; in other designs, such a fraction may range from about 0.2 wt. % to about 0.5 wt. %; in other designs, such a fraction may range from about 0.5 wt. % to about 1 wt. %; in other designs, such a fraction may range from about 1 wt. % to about 2 wt. %; in other designs, such a fraction may range from about 2 wt. % to about 3 wt. %; in other designs, such a fraction may range from about 3 wt. % to about 5 wt. %; in other designs, such a fraction may range from about 5 wt. % to about 20 wt. %; in other designs, such a fraction may range from about 5 wt. % to about 20 wt. %. Depending on the type and chemistry of (S)-comprising co-solvents, in some designs, an excessive amount of such co-solvents may worsen the SEI stability. For example, the use of small to moderate amounts (e.g., from about 0.05 wt. % to about 3-5 wt. %) of propane sulfone may improve cathode CEI and enhance high-temperature performance of cells with high voltage cathodes (e.g., charged to about 4.2-4.4 V or higher potentials vs. Li/Li+), but may slightly worsen the anode SEI. Higher fractions of propane sulfone, however, may induce substantially worse stability of the anode SEI and lead to undesirably poor cell performance in some designs. On the other hand, significantly higher fraction of sulfolane may maintain quite good anode SEI stability in some designs.

In some designs, in the context of one or more embodiments of the present disclosure, it may be beneficial (e.g., for improved stability or increased maximum cell voltage or performance at elevated or room or low temperatures) to utilize one, two, three or more electrolyte co-solvents (at suitable levels or weight fractions) of the Formula 1 (200), Formula 2 (400), Formula 3 (600) and/or Formula 4 (800) in the electrolyte together with the suitable fraction (e.g., from about 0.05 wt. % to about 10 wt. %) of various (different from those described by Formulas 1-4) nitrogen (N)-comprising co-solvents (e.g., dimethylacetamide (DMAc), ethylene glycol bis(propionitrile)ether (EGBE), fumaronitrile (FM), succinonitrile, glutaronitrile, adiponitrile, p-toluenesulfonyl isocyanate, 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, 1,1′-sulfonyldiimidazole, 1,3,5-hexanetricarbonitrile, 1,3,6-hexanetricarbonitrile (HTCN), pyridine boron trifluoride (PBF), 3-fluoro pyridine boron trifluoride (3F-PBF), pyrazine boron trifluoride, among others) as additives, among other electrolyte components and co-solvents. In some designs, such a total fraction of N-containing co-solvents may range from about 0.01 wt. % to about 0.2 wt. %; in other designs, such a fraction may range from about 0.2 wt. % to about 0.4 wt. %; in other designs, such a fraction may range from about 0.4 wt. % to about 0.8 wt. %; in other designs, such a fraction may range from about 0.8 wt. % to about 2 wt. %; in other designs, such a fraction may range from about 2 wt. % to about 3 wt. %; in other designs, such a fraction may range from about 3 wt. % to about 5 wt. %; in other designs, such a fraction may range from about 5 wt. % to about 10 wt. %. Higher fractions of such N-containing additives may induce undesirably inferior anode SEI properties or cathode CEI properties, in some designs. In some designs, it may be advantageous (e.g., for better stability or better rate performance or lower charge transfer resistance or for other cell performance benefits) for at least some (e.g., about 10-100 wt. %) of such nitrogen (N)-comprising co-solvents to comprise from around 5 to around 18 carbon (C) atoms per molecule (e.g., from around 5 to around 6 or from around 7 to around 9 or from around 10 to around 12 or from around 13 to around 18). In some designs, it may be advantageous for at least some (e.g., about 10-100 wt. %) of such nitrogen (N)-comprising co-solvents to comprise from around 1 to around 6 oxygen (O) atoms per molecule (e.g., from around 1 to around 3 or from around 4 to around 6). In some designs, some or all of such O atoms are within ether functional groups (positions). In some designs, some or all of such O atoms are within ester functional groups (positions). In some designs, it may be advantageous for at least some (e.g., 10-100 wt. %) of such nitrogen (N)-comprising co-solvents to comprise 2 (e.g., as in dinitriles), 3 (e.g., as in trinitriles) or more nitrogen (N) atoms per molecule (in some designs, 3 or more N atoms per molecule). In the designs where at least some of such N-comprising co-solvents comprise 2 N or more atoms per molecule (e.g., as in dinitriles), it may be advantageous for such solvent molecules to be aliphatic. In some designs, it may be advantageous for at least some (e.g., about 10-100 wt. %) of such nitrogen (N)-comprising co-solvents (e.g., those that comprise 3 or more N atoms per molecule, to provide some illustrative examples) to exhibit a non-linear molecular geometry. In some designs, it may be advantageous for at least some (e.g., about 10-100 wt. %) of such nitrogen (N)-comprising co-solvents to exhibit a trigonal planar molecular geometry. Note that in some designs, some of such disclosed nitrogen (N)-comprising co-solvents (e.g., nitriles comprising 2 or 3 or more N atoms per molecule) may be advantageous to use in more common electrolyte compositions (e.g., electrolyte compositions that do not utilize one, two, three or more electrolyte co-solvents of the Formula 1 (200), Formula 2 (400), Formula 3 (600) and/or Formula 4 (800)).

In some designs, in the context of one or more embodiments of the present disclosure, it may be beneficial (e.g., for improved stability or increased maximum cell voltage or performance at elevated or room or low temperatures) to utilize one, two, three or more electrolyte co-solvents (at suitable levels or weight fractions) of the Formula 1 (200), Formula 2 (400), Formula 3 (600) and/or Formula 4 (800) in the electrolyte together with the suitable fraction (e.g., from about 0.05 wt. % to about 10 wt. %) of various (different from those described by Formulas 1-4) phosphorous (P)-comprising or boron (B)-comprising co-solvents (e.g., tris(trimethylsilyl)phosphite (TMSPi), tris(2.2.2-trifluoroethyl phosphite (TTFPi), triphenyl phosphite (TPPi), triallyl phosphate (TAP), triethylborate (TEB), tris(trimethylsilyl)borate (TMSB), tris(2,2,3,3,3-pentafluoropropyl) phosphate (5F-TPrP), tris(1,1,1,3,3,3-hexafluoropropan-2-yl) phosphate (HFiP), tris(1,1,1,3,3,3-hexafluoropropan-2-yl) phosphite (THFPP), etc.) as additives, among other electrolyte co-solvents. In some designs, such a total fraction of P-comprising and B-comprising solvents may range from about 0.01 wt. % to about 0.2 wt. %; in other designs, such a fraction may range from about 0.2 wt. % to about 0.4 wt. %; in other designs, such a fraction may range from about 0.4 wt. % to about 0.8 wt. %; in other designs, such a fraction may range from about 0.8 wt. % to about 2 wt. %; in other designs, such a fraction may range from about 2 wt. % to about 3 wt. %; in other designs, such a fraction may range from about 3 wt. % to about 5 wt. %; in other designs, such a fraction may range from about 5 wt. % to about 10 wt. %. Higher fractions of such P-containing additives may induce undesirably inferior anode SEI properties, in some designs.

In some designs, electrolyte compositions comprising one, two, three or more suitable electrolyte co-solvents of the Formula 1 (200), Formula 2 (400), Formula 3 (600) and/or Formula 4 (800) may also advantageously comprise one or more of: various lactones, various phosphorous based solvents (e.g., dimethyl methylphosphonate, triphenyl phosphate, etc.), various silicon based solvents, various ethers (e.g., dioxolane, monoglyme, diglyme, triglyme, tetraglyme, and polyethylene oxide, etc.), various dinitriles (e.g., succinonitrile, adiponitrile, and glutaronitrile) and various ionic liquids (e.g., imidazoliums, pyrrolidiniums, piperidiniums, etc.), among other co-solvents. In some designs, at least some of such lactones, phosphorous based solvents, silicon-based solvents, ethers, dinitriles may be (either fully or partially) fluorinated. In some designs, the fraction of all lactones, phosphorous based solvents, silicon-based solvents, ethers and dinitriles may range from about 0.05 wt. % to about 20 wt. % (as a fraction of all solvents in the electrolyte).

In some designs, electrolyte compositions comprising one, two, three or more suitable electrolyte co-solvents of the Formula 1 (200), Formula 2 (400), Formula 3 (600) and/or Formula 4 (800) may also advantageously comprise one or more of hydrofluoric acid (HF) scavengers or one or more additive components that reduce or minimize decomposition of (or neutralize some of the undesirably over-reactive species produced in such a decomposition of) LiPF₆ salt or other F-comprising salts or F-comprising solvents, among other suitable electrolyte components. Illustrative examples of such additives include, but are not limited to: LiDFOB salt, triphenylphosphine oxide, various tris(trimethylsilyl)-based compounds, dimethylacetamide, 4-propyl-[1,3,2]-dioxathiolane-2,2-dioxide, 3-sulfolene, various chelating agents such as crown ethers and nitriles/imines, among many others.

In one or more embodiments of the present disclosure, the inventors found that it may be advantageous (e.g., for improved performance and stability) to have an electrolyte to be configured with a relatively small average density of all the solvents in the electrolyte mixture (in other words, to have electrolyte with a relatively small density of the final solution of the electrolyte solvents). Note that the addition of salt(s) to electrolyte increases electrolyte density. Since the amount of salt may vary, we specifically indicate the density of the solvent mixtures. In some designs, having a significant fraction of the low-density co-solvents of the Formula 1 (200), Formula 2 (400), Formula 3 (600) and/or Formula 4 (800) may be used in the electrolyte in order to lower its density. In other designs, other mixtures or co-solvents may be used. These lower solvent density-related benefits may be related to the impacts of the average packing of solvent molecules in electrolyte solution or the need to have higher weight and volume fractions of relatively lower density solvents on the ion mobility and solvent mobility in the electrolyte, in the SEI and/or in the CEI. In some designs, it may be advantageous for the density of the solvent mixture in the electrolyte to remain in the range from about 0.80 g/cc to about 1.2 g/cc initially or during an operational life of the battery. In some designs (depending on the cell chemistry, operating conditions, areal capacity loadings, thickness of the electrodes, maximum cell voltage and other factors), it may be advantageous for the density of the solvent mixture in the electrolyte to remain in the range from about 0.80 g/cc to about 0.95 g/cc initially or during an operational life of the battery (when measured at standard conditions). In some designs, it may be advantageous for the density of the solvent mixture in the electrolyte to remain in the range from about 0.95 g/cc to about 1.00 g/cc initially or during an operational life of the battery. In some designs, it may be advantageous for the density of the solvent mixture in the electrolyte to remain in the range from about 1.00 g/cc to about 1.05 g/cc initially or during an operational life of the battery. In some designs, it may be advantageous for the density of the solvent mixture in the electrolyte to remain in the range from about 1.05 g/cc to about 1.10 g/cc initially or during an operational life of the battery. In some designs, it may be advantageous for the density of the solvent mixture in the electrolyte to remain in the range from about 1.10 g/cc to about 1.15 g/cc initially or during an operational life of the battery. In some designs, it may be advantageous for the density of the solvent mixture in the electrolyte to remain in the range from about 1.15 g/cc to about 1.20 g/cc initially or during an operational life of the battery.

In one or more embodiments of the present disclosure, the inventors found that it may be advantageous (e.g., for improved performance and stability) for the disclosed cells to comprise an electrolyte (a mixture of all the salts and solvents, including additives) to exhibit a relatively small average density, such as from about 0.85 g/cc to about 1.25 g/cc initially or during an operational life of the battery. In some designs, the electrolyte density may range from about 0.85 g/cc to about 0.90 g/cc; in other designs, from about 0.90 g/cc to about 0.95 g/cc; in other designs, from about 0.95 g/cc to about 1.00 g/cc; in other designs, from about 1.00 g/cc to about 1.05 g/cc; in other designs, from about 1.05 g/cc to about 1.10 g/cc; in other designs, from about 1.10 g/cc to about 1.15 g/cc; in other designs, from about 1.15 g/cc to about 1.20 g/cc; in yet other designs, from about 1.20 g/cc to about 1.25 g/cc. Note that the overall density of the electrolyte may change before and after “cell formation” (at the factory) and may further change during cycling (during use/operating of the device). Such changes, however, are often predictable and the initial electrolyte density may typically be estimated from the density of the electrolyte extracted from “formed” or even “cycled”/used battery cells. Also note that in some designs, the cells may utilize electrolytes with densities outside the range specified above.

In one or more embodiments of the present disclosure, the inventors found that it may be advantageous (e.g., for improved performance and stability) for the disclosed cells (particularly for automotive cells or cells with higher areal capacity loading electrodes) to comprise an electrolyte (a mixture of all the salts and solvents, including additives) that exhibit relatively small viscosity values (often below those that are normally used in commercial cells of relevant size or capacity loadings). Electrolyte viscosity values may be tuned by changing the electrolyte compositions (e.g., increasing the fraction of low-viscosity solvents or by reducing the fraction of salts or optimizing the solvation energy of Li+ solvation shells or by identifying the mix of solvents and salts or by adding other electrolyte components, among other means). In some designs, for example, such electrolyte viscosity values at room temperatures may preferably range from about 0.6 cP (centipoise) to about 6 cP, initially (e.g., pre-cycling) or during an operational life of the battery. In some cell designs, the electrolyte viscosity may range from about 0.6 cP to about 2 cP; in other designs, the electrolyte viscosity may range from about 2 cP to about 3 cP; in other designs, the electrolyte viscosity may range from about 3 cP to about 4 cP; in other designs, the electrolyte viscosity may range from about 4 cP to about 5 cP and in yet other designs, the electrolyte viscosity may range from about 5 cP to about 6 cP. Note that the overall viscosity of the electrolyte may change before and after “cell formation” (at the factory) and may further change during cycling (during use/operating of the device). Such changes, however, are often predictable and the initial electrolyte viscosity may typically be estimated from the viscosity of the electrolyte extracted from “formed” or even “cycled”/used battery cells. Also note that in some designs, the cells may utilize electrolytes with viscosities outside the range specified above (e.g., above 6 cP at room temperature), especially if high salt concentration is needed for a particular application.

In one or more embodiments of the present disclosure, it may be advantageous to have a total salt concentration in the electrolyte in the range from about 0.8M to about 2.0M (e.g., from about 0.8M to about 1.2M or from about 1.2M to about 1.5M or from about 1.5M to about 2.0M, depending on the cell design peculiarities or cell operating conditions), while utilizing a mixture of two, three or more salts. Lower than about 0.8M salt concentration in the electrolyte may lead to reduced cell stability in some designs (e.g., when high-capacity anode materials are used), particularly when high areal capacity electrodes are used (e.g., above about 4 mAh/cm²). Higher salt concentration in the electrolyte may lead to reduced rate performance and, in some designs, to reduced cell stability. Such reduced performance characteristics may be related to reduced mobility of Li⁺ cations in the electrolyte in some designs. Higher salt concentration may also lead to increased electrolyte density and cost in some designs, which may be undesirable for some applications. The optimal salt concentration may depend on the particular cell design and electrolyte composition.

In some cases, combinations of salts may exhibit enhanced Li⁺ mobility than individual salts of the same concentration. In some designs, such salts may be selected so that the Li salts (or their solvated counterparts) form a eutectic system (with a reduced melting point). In one example, several Li imide salts (e.g., a mixture of SO₂FN⁻(Li⁺)SO₂F and a CF₃SO₂N⁻(Li⁺)SO₂CF₃ salts or a mixture of CF₃SO₂N⁻(Li⁺)SO₂CF₃ and CF₃CF₂SO₂N⁻(Li⁺)SO₂CF₃ or a mixture of CF₃SO₂N⁻(Li⁺)SO₂CF₃ and CF₃CF₂SO₂N⁻(Li⁺)SO₂CF₂CF₃, etc.) may form such a system. In some designs, such salts and their relative fractions may be selected to induce freezing point depression. In some designs, the most favorable relative fractions of the salts may be selected to minimize the freezing point (via such a freezing point depression). In some designs, other Li and non-Li salts may be added in small quantities (e.g., from about 0.001M to about 0.500M) to further depress the electrolyte melting point, improve anode SEI properties, improve cathode CEI, improve high voltage stability, improve high temperature or low temperature performance and/or reduce dissolution of active materials or their components. In some designs, the non-Li salts may be salts of Mg, K, Ca or Na. In some designs, the non-Li salts may be salts of rare earth metals (e.g., La).

In some designs, electrolyte compositions comprising one, two, three or more suitable electrolyte co-solvents of the Formula 1 (200), Formula 2 (400), Formula 3 (600) and/or Formula 4 (800) may also advantageously utilize two or more salts (e.g., two salts or three salts or four salts or five salts, etc.), where it may be further advantageous for at least one of the salts to comprise LiPF₆ (in the case of rechargeable Li or Li-ion batteries). In some designs, the incorporation of such salts may enhance properties (cycle stability, resistance, thermal stability, performance at high or low temperatures, etc.) of the cathode CEI or the anode SEI or provide other performance advantages. In some designs, it may be further advantageous for at least one other salt to also be a salt of Li. Examples of some of such suitable salts include, but are not limited to: fluorosulfonylimide (LiFSI), trifluoromethanesulfonylimide (LiTFSI), perfluoroethylsulfonylimide (LiBETI) and other Li imide salts, Li bis(oxalatooxalate)borate (LiBOB), Li difluoro(oxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), trifluorochloroborate (LiBF₃Cl), etc.). In some designs, it may be advantageous for the concentration of all (one or more) other (non-LiPF₆) salts in the electrolyte to range from around 0.01M to around 0.8M (in some designs, from around 0.01M to around 0.1M; in other designs, from around 0.1M to around 0.2M; in other designs, from around 0.2 M to around 0.3M; in other designs, from around 0.3M to around 0.4M; in other designs, from around 0.4M to around 0.5M; in other designs, from around 0.5M to around 0.6M; in other designs, from around 0.6M to around 0.7M; in other designs, from around 0.7M to around 0.8M).

In some designs, it may be further advantageous for at least one other (non-LiPF₆) salt to be electrochemically unstable in the electrolyte (e.g., decompose on the anode) upon reduction of the anode potential to below about 0.3-2.3 V vs. Li/Li⁺ or decompose on the cathode upon oxidation at the cathode when cathode potential increases to above around 3.0-3.5 V vs. Li/Li⁺. In some designs, it may be advantageous for the salt electrochemical reduction to take place at above about 0.3 V vs. Li/Li+, more preferably above about 1V vs. Li/Li+(and in some designs, more preferably above about 1.5V vs. Li/Li+). In some designs, it may be further advantageous for the non-LiPF₆ salt in the electrolyte to induce or catalyze electrolyte reduction at above about 0.3 V vs. Li/Li+, and in some designs, more preferably above about 1V vs. Li/Li+(and in some designs, more preferably above about 1.5V vs. Li/Li+). In some designs, it may be further advantageous for the (e.g., partially decomposed) non-LiPF₆ salt in the electrolyte to react with at least some of the solvent molecules in the electrolyte to form oligomers. In some designs, a non-LiPF₆ salt may be LiFSI salt. Furthermore, in the case of the electrolyte comprising both LiPF₆ salt and LiFSI salt, in some designs, the ratio of the molar fractions of LiPF₆ and LiFSI salts may preferably be in the range from about 100:1 to about 1:1. The exact optimal ratio may depend on the electrode characteristics (e.g., thickness, amount of binder, density, anode and cathode composition and capacity, etc.), electrolyte solvent mix utilized and cycling regime (temperature, cell voltage range, etc.).

In some designs, it may be advantageous to have a total salt concentration in the electrolyte in the range from about 0.8M to about 2.0M, while utilizing a small fraction of at least one at least partially fluorinated solvent in the electrolyte mixture in the range from about 1 to about 30 vol. %, as a fraction of all the solvents in the electrolyte. In some designs, it may be further advantageous for the electrolyte solvent mixture to comprise both linear and cyclic molecules. In some designs, it may be advantageous for at least one of the cyclic molecules to comprise fluorine atoms. In some designs, it may be preferred for the electrolyte to comprise a fluoroethylene carbonate (FEC) co-solvent in electrolyte (e.g., in the range from about 1 to about 30 vol. %, as a fraction of all the solvents in the electrolyte). Higher FEC content (e.g., above 10-30 vol. %) may reduce cell performance at elevated temperatures (e.g., above about 35° C.) in some designs, particularly if the cathode of the cell is exposed to high potentials (e.g., above about 4.2-4.4 V vs. Li/Li+). In some designs, it may further be advantageous for the electrolyte solvent mixture to comprise one, two, three or more suitable electrolyte co-solvents of the Formula 1 (200), Formula 2 (400), Formula 3 (600) and/or Formula 4 (800). In some designs, it may also be advantageous for the electrolyte to comprise one or more other cyclic carbonates in addition to FEC (or other fluorinated cyclic carbonates). In some designs, it may be advantageous for the other cyclic carbonates to comprise ethylene carbonate (EC), vinylene carbonate (VC), vinyl ethylene carbonate (VEC), propylene carbonate (PC) or another cyclic carbonate. Furthermore, in some designs, the vol. ratio of FEC (or other fluorinated cyclic carbonates) to other cyclic carbonates may preferably be in the range from about 5:1 to about 1:20. In some designs, it may be preferable for the electrolyte to comprise from about 1 to about 10 vol. % VC as a volume fraction of all solvents in the electrolyte (in some designs, from about 1 vol. % to about 3 vol. %; in other designs, from about 3 vol. % to about 5 vol. %; in yet other designs, from about 5 vol. % to about 10 vol. %). In some designs, it may be preferable for the electrolyte to comprise from about 1 to about 10 vol. % VEC (in some designs, from about 1 vol. % to about 3 vol. %; in other designs, from about 3 vol. % to about 5 vol. %; in yet other designs, from about 5 vol. % to about 10 vol. %). In some designs, it may be preferable for the electrolyte to comprise from about 1 to about 20 vol. % PC. In some designs, it may be preferable for the electrolyte to comprise from about 1 to about 20 vol. % EC. The exact optimal ratio may depend on the electrode characteristics (e.g., thickness, amount of binder, density, anode and cathode composition and capacity, etc.), electrolyte solvent mix utilized and cell cycling regime (temperature, voltage range, etc.).

In one illustrative example, consumer Li-ion battery cell with a capacity of ˜1 Ah may comprise: (i) an anode with Si-based nanocomposite active material (with specific reversible capacity of ˜1520 mAh/g when normalized by the weight of active materials in the anode) casted on Cu current collector foil from an aqueous suspension comprising a PAA-based binder and a carbon black conductive additive, (ii) a cathode with high-voltage LCO active material (with specific reversible capacity of ˜190 mAh/g when normalized by the weight of active materials in the cathode) casted on Al current collector foil from an organic solvent suspension comprising a PVDF-based binder and a carbon black conductive additive, anode:cathode areal capacity ratio of about 1.1:1 and areal reversible capacity loading of about 3.6 mAh/cm², charge voltage of ˜4.4V, (iii) a polymer separator and (iv) an electrolyte comprising: (a) about 1.2M LiPF₆ mixed with about 0.07M LiDFP salt solution in the following mixture of solvents: about 12 vol. % (about 16.8 wt. %) FEC (fluorinated cyclic carbonate), about 4 vol. % (about 5.2 wt. %) VC (cyclic carbonate), about 10 vol. % (about 11.6 wt. %) PC (cyclic carbonate), about 4 vol. % (about 5.1 wt. %) EC (cyclic carbonate), about 20 vol. % (about 18.8 wt. %) DEC (linear carbonate), about 38 vol. % (about 31.7 wt. %) ethyl isobutyrate (EI, branched ester of Formula 1), about 10 vol. % (about 8.6 wt. %) ethyl propionate (EP, linear ester), about 1 vol. % (about 1.3 wt. %) propane sultone or propene sultone (PS or PES, sulfur-comprising additive), about 1 vol. % (about 0.9 wt. %) adiponitrile (ADN, nitrogen-comprising additive).

In another one illustrative example, an automotive Li-ion battery cell with a capacity of ˜40 Ah may comprise: (i) an anode with Si-based nanocomposite active material (with specific reversible capacity of ˜1550 mAh/g when normalized by the weight of active materials in the anode) casted on Cu current collector foil from an aqueous suspension comprising a PAA-based binder and a carbon black conductive additive, (ii) a cathode with Ni-rich (NCM811) active material (with specific reversible capacity of ˜200 mAh/g when normalized by the weight of active materials in the cathode) casted on Al current collector foil from an organic solvent suspension comprising a PVDF-based binder and a carbon black conductive additive, anode:cathode areal capacity ratio of about 1.1:1 and areal reversible capacity loading of about 4.4 mAh/cm², charge voltage of ˜4.2V, (iii) a polymer separator and (iv) an electrolyte comprising: (a) about 1.0M LiPF₆ mixed with about 0.2M LiFSI and about 0.07M LiDFP salt solution in the following mixture of solvents: about 7 vol. % (about 9.7 wt. %) FEC (fluorinated cyclic carbonate), about 3 vol. % (about 3.9 wt. %) VC (cyclic carbonate), about 10 vol. % (about 11.5 wt. %) PC (cyclic carbonate), about 15 vol. % (about 18.9 wt. %) EC (cyclic carbonate), about 20 vol. % (about 18.6 wt. %) DEC (linear carbonate), about 38 vol. % (about 31.4 wt. %) ethyl isobutyrate (EI, branched ester of Formula 1), about 1 vol. % (about 0.8 wt. %) ethyl propionate (EP, linear ester), about 5.5 vol. % (about 4.7 wt. %) methyl butyrate (MB, linear ester), about 0.5 vol. % (about 0.5 wt. %) adiponitrile (ADN, nitrogen-comprising additive). The density of the electrolyte solvent mix in this electrolyte is estimated as ˜1.05 g/cc.

In another one illustrative example, an automotive Li-ion battery cell with a capacity of ˜80 Ah may comprise: (i) an anode with Si-based nanocomposite active material (with specific reversible capacity of ˜1670 mAh/g when normalized by the weight of active materials in the anode) casted on Cu current collector foil from an aqueous suspension comprising a CMC/SBR-based binder and a carbon nanotube conductive additive, (ii) a cathode with Ni-rich NCM active material (with specific reversible capacity of ˜200 mAh/g when normalized by the weight of active materials in the cathode) casted on Al current collector foil from an organic solvent suspension comprising a PVDF-based binder and a carbon black conductive additive, anode:cathode areal capacity ratio of about 1.1:1 and areal reversible capacity loading of about 4.6 mAh/cm², charge voltage of ˜4.2V, (iii) a polymer separator and (iv) an electrolyte comprising: (a) about 1.1M LiPF₆ mixed with about 0.1M LiFSI salt solution in the following mixture of solvents: about 7 vol. % (about 10.1 wt. %) FEC (fluorinated cyclic carbonate), about 3 vol. % (about 4.0 wt. %) VC (cyclic carbonate), about 7 vol. % (about 9.1 wt. %) EC (cyclic carbonate), about 7 vol. % (about 8.3 wt. %) PC (cyclic carbonate), about 5 vol. % (about 5.6 wt. %) 4-ethyl-1,3-dioxolan-2-one (cyclic carbonate with a longer branch); about 10 vol. % (about 9.6 wt. %) DEC (linear carbonate), about 5 vol. % (about 4.7 wt. %) ethyl isopropyl carbonate (branched linear carbonate), about 40 vol. % (about 34.2 wt. %) ethyl isobutyrate (EI, branched ester of Formula 1), about 5 vol. % about (4.5 wt. %) 2-cyanoethyl isobutyrate (branched ester of Formula 2), about 5 vol. % (about 4.4 wt. %) ethyl propionate (EP, linear ester), about 5 vol. % (about 4.4 wt. %) methyl butyrate (MB, linear ester), about 0.5 vol. % (about 0.5 wt. %) adiponitrile (ADN, nitrogen-comprising additive), about 0.5 vol. % (about 0.5 wt. %) 1,3,6-hexanetricarbonitrile (HTCN, nitrogen-comprising additive). The density of the electrolyte solvent mix in this electrolyte is ˜1.01 g/cc.

In another one illustrative example, a large automotive Li-ion battery cell with a capacity of ˜200 Ah may comprise: (i) an anode with primarily (e.g., about 75-100 wt. %) carbon (e.g., artificial and/or synthetic graphite and/or soft carbon and/or hard carbon, etc.) active material (with average specific reversible capacity in the range from about ˜300 to about ˜400 mAh/g) when normalized by the weight of active carbon materials in the anode) casted on Cu current collector foil from an aqueous suspension comprising a CMC/SBR-based (or another suitable) binder and a carbon black conductive additive, (ii) a cathode with LFP or LFMP or LVOP active material (with specific reversible capacity in the range from about ˜140 to about ˜340 mAh/g mAh/g when normalized by the weight of active materials in the cathode) casted on Al current collector foil from an organic solvent suspension comprising a PVDF-based (or another suitable) binder and a carbon black conductive additive, anode:cathode areal capacity ratio of about 1.1:1 and areal reversible capacity loading in the range from about 1.6 to about 4.4 mAh/cm² that may be charged to a maximum voltage in the range from about ˜3.8 to about ˜5 V, (iii) a polymer or polymer-ceramic separator and (iv) an electrolyte comprising: about 1.1M LiPF₆ mixed with about 0.05M LiBF₄ salt solution in the following mixture of solvents: about 3.5 wt. % FEC (fluorinated cyclic carbonate), about 0.5 wt. % VC (cyclic carbonate), about 10 wt. % EC (cyclic carbonate), about 70 wt. % ethyl isobutyrate (EI, branched ester of Formula 1), about 10.5 wt. % ethyl propionate (EP, linear ester), about 0.5 wt. % 3-{[1,3-bis(2-cyanoethoxy)propan-2-yl]oxy}propanenitrile (nitrogen-comprising additive).

In another one illustrative example, a small automotive prototype Li-ion battery cell with a capacity of ˜25 mAh may comprise: (i) an anode with Si-based nanocomposite active material (with specific reversible capacity of ˜1550 mAh/g when normalized by the weight of active materials in the anode) casted on Cu current collector foil from an aqueous suspension comprising a PAA-based binder (which may include a metal salt of PAA) and a carbon black conductive additive, (ii) a cathode with Ni-rich (NCM811) active material (with specific reversible capacity of ˜200 mAh/g when normalized by the weight of active materials in the cathode) casted on Al current collector foil from an organic solvent suspension comprising a PVDF-based binder (or another suitable binder) and a carbon black conductive additive, wherein the anode:cathode areal capacity ratio is about 1.1:1 and areal reversible capacity loading of about 5.1 mAh/cm², charge voltage of ˜4.2V, (iii) a polymer separator and (iv) an electrolyte (labeled ELY #1) comprising: (a) about 9.26 mol. % LiPF₆, about 1.85 mol. % LiFSI, about 0.46 mol. % LiDFP, about 15.85 mol. % FEC (fluorinated cyclic carbonate), about 4.48 mol. % VC (cyclic carbonate), about 6.05 mol. % PC (cyclic carbonate), about 13.89 mol. % EC (cyclic carbonate), about 48.16 vol. % ethyl isobutyrate (EI, branched ester of Formula 1 with 6 carbon atoms per molecule, C₆H₁₂O₂). The density of the electrolyte solvent mix in this electrolyte is ˜0.99 g/cc.

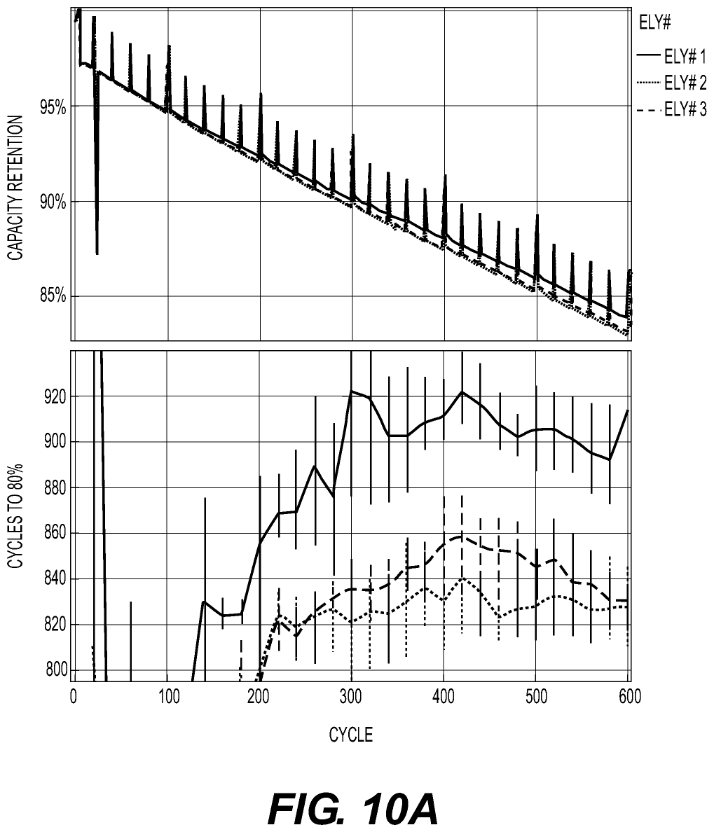

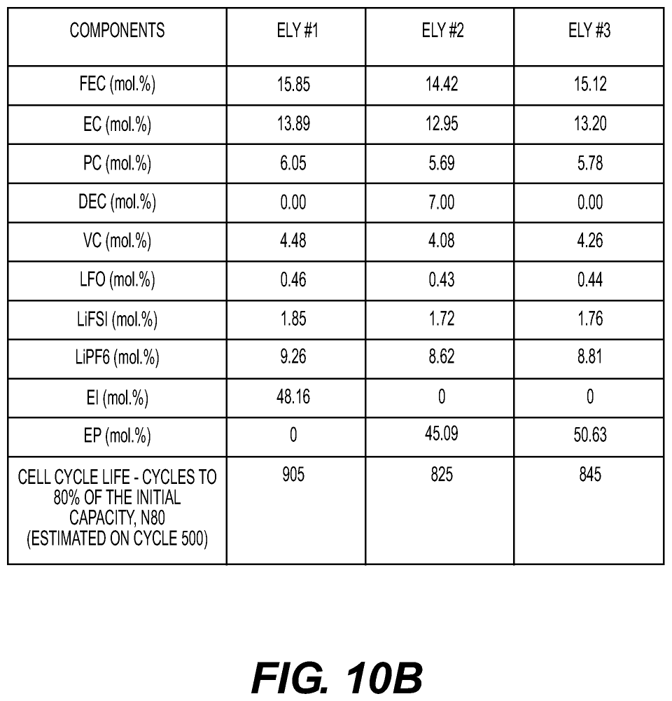

FIG. 10A illustrates the positive impact of the addition of the branched ester EI on the performance improvements of the above-mentioned illustrative example cell. We observe that otherwise analogous Li-ion battery cells built with two other electrolytes ELY #2 and ELY #3 that have similar composition of the solvent mix (except that EI is replaced with a linear ester ethyl propionate (EP) and linear carbonate (DEC) in the ELY #2 or simply with a linear ester (EP) in the ELY #3) offer inferior cycle stability. FIG. 10B shows the table with the molar composition of the electrolytes ELY #1, ELY #2 and ELY #3 and cell cycle life estimated at cycle 500.

In another one illustrative example, an automotive Li-ion battery cell may comprise: (i) an anode with Si-based nanocomposite active material (with specific reversible capacity of ˜1550 mAh/g when normalized by the weight of active materials in the anode) casted on Cu current collector foil from an aqueous suspension comprising a PAA-based binder and a carbon black conductive additive, (ii) a cathode with Ni-rich (NCM811) active material (with specific reversible capacity of ˜200 mAh/g when normalized by the weight of active materials in the cathode) casted on Al current collector foil from an organic solvent suspension comprising a PVDF-based binder and a carbon black conductive additive, anode:cathode areal capacity ratio of about 1.1:1 and areal reversible capacity loading of about 5.1 mAh/cm², charge voltage of ˜4.2V, (iii) a suitable polymer separator and (iv) an electrolyte ELY #4 comprising: (a) about 8.89 mol % LiPF₆, about 1.79 mol. % LiFSI, about 0.44 mol. % LiDFP, about 15.28 mol. % FEC (fluorinated cyclic carbonate), about 4.13 mol. % VC (cyclic carbonate), about 5.87 mol. % PC (cyclic carbonate), about 12.35 mol. % EC (cyclic carbonate), about 27.07 mol. % of EP (linear ester) and about 23.19 vol. % ethyl isobutyrate (EI, branched ester of Formula 1). The density of the electrolyte solvent mix in this electrolyte is ˜0.97 g/cc.

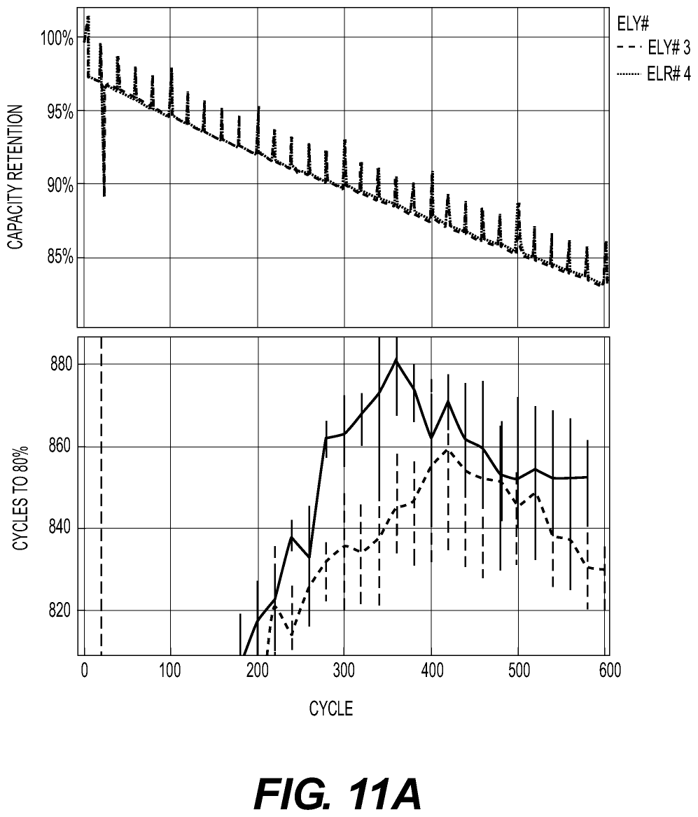

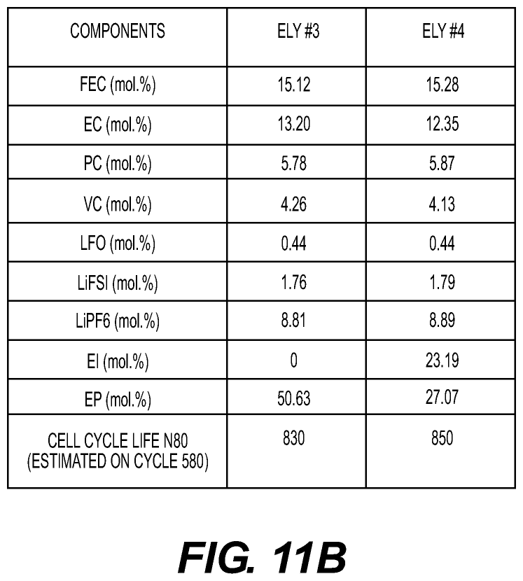

FIG. 11A illustrates the electrochemical stability of such a cell with ELY #4 that comprises both EI and EP (e.g., suitable mixture of EI and EP) and compares it with the somewhat inferior stability of otherwise analogous cell that comprises ELY #3 with no EI in the electrolyte composition. FIG. 11B shows the table with the molar composition of the electrolytes ELY #3 and ELY #4 and cycle life of the cells estimated on cycle 580.

In another one illustrative example, a consumer Li-ion battery cell with a capacity of ˜175 mAh may comprise: (i) an anode with Si-based nanocomposite active material (with specific reversible capacity of ˜1550 mAh/g when normalized by the weight of active materials in the anode) casted on Cu current collector foil from an organic solvent suspension comprising a PVA-based binder and a carbon black conductive additive, (ii) a cathode with LCO active material (with specific reversible capacity of ˜175 mAh/g when normalized by the weight of active materials in the cathode) casted on Al current collector foil from an organic solvent suspension comprising a PVDF-based binder and a carbon black conductive additive, anode:cathode areal capacity ratio of about 1.08:1 and areal reversible anode capacity loading of about 2.4 mg/cm², charge voltage of ˜4.4V, (iii) a polymer separator and (iv) an electrolyte ELY #5 comprising: (a) about 12.41 mol % LiPF₆, about 0.51 mol. % LiDFP, about 4.36 mol. % FEC (fluorinated cyclic carbonate), about 3.21 mol. % VC (cyclic carbonate), about 32.70 mol. % PC (cyclic carbonate) and about 46.81 mol. % of EIV (ethyl isovalerate) (branched ester of Formula 1). The density of the electrolyte solvent mix in this electrolyte is ˜0.90 g/cc.

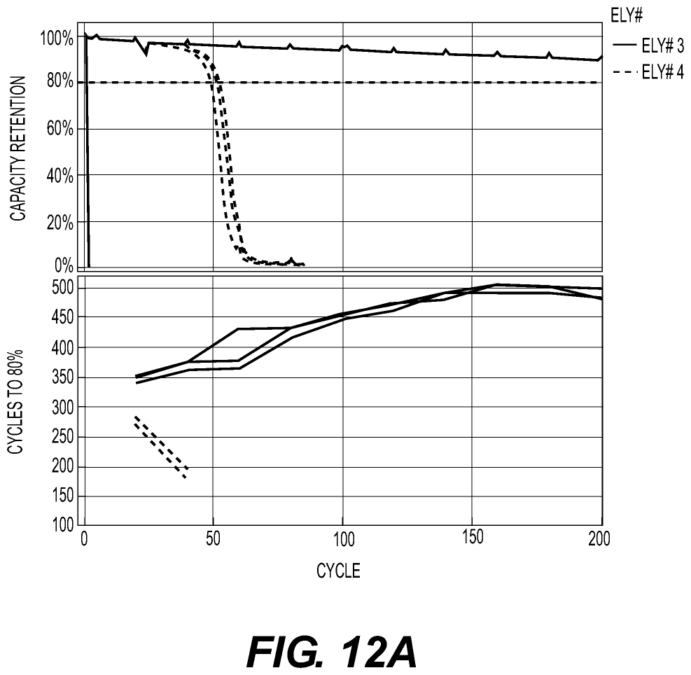

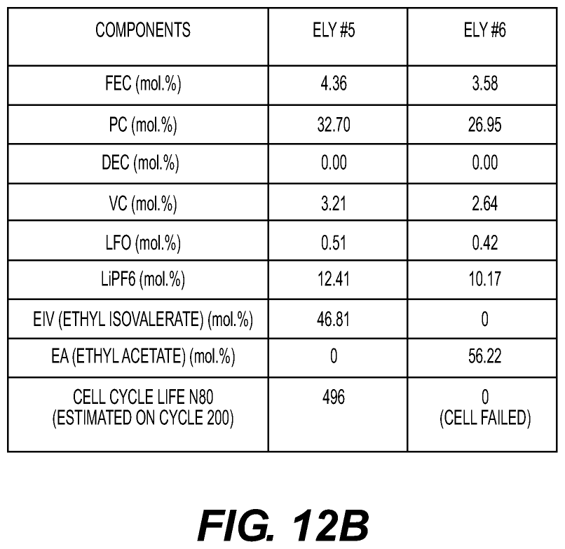

FIG. 12A illustrates the electrochemical stability of such a cell with ELY #5 that comprises EIV and compares it with the inferior stability of otherwise analogous cell that comprises ELY #6 with ethyl acetate in its composition. FIG. 12B shows the table with the molar composition of the electrolytes ELY #5 and ELY #6 and cycle life of the cells estimated on cycle 200, demonstrating a positive impact of branched ester EIV. Note that in these examples, the Li-ion battery cell comprising ELY #6 (with ethyl acetate) failed before reaching 50 cycles whereas the Li-ion battery cell comprising ELY #5 (with EIV, branched ester of Formula 1) would likely achieve a cycle life of close to 500 cycles.

In another one illustrative example, a consumer Li-ion battery cell with a capacity of ˜175 mAh may comprise: (i) an anode with Si-based nanocomposite active material (with specific reversible capacity of ˜1550 mAh/g when normalized by the weight of active materials in the anode) casted on Cu current collector foil from an organic solvent suspension comprising a PVA-based binder and a carbon black conductive additive, (ii) a cathode with LCO active material (with specific reversible capacity of ˜175 mAh/g when normalized by the weight of active materials in the cathode) casted on Al current collector foil from an organic solvent suspension comprising a PVDF-based binder and a carbon black conductive additive, anode:cathode areal capacity ratio of about 1.08:1 and areal reversible anode capacity loading of about 2.4 mg/cm², charge voltage of ˜4.4V, (iii) a polymer separator and (iv) an electrolyte ELY #7 comprising: (a) about 11.97 mol % LiPF₆, about 4.20 mol. % FEC (fluorinated cyclic carbonate), about 3.06 mol. % VC (cyclic carbonate), about 31.83 mol. % PC (cyclic carbonate), about 35.88 mol % of EI (ethyl isobutyrate) (branched ester of Formula 1) and about 13.05 mol. % of TI (2,2,2-trifluoroethyl isobutyrate) (branched ester additive of Formula 2). The density of the electrolyte solvent mix in this electrolyte is ˜0.95 g/cc.

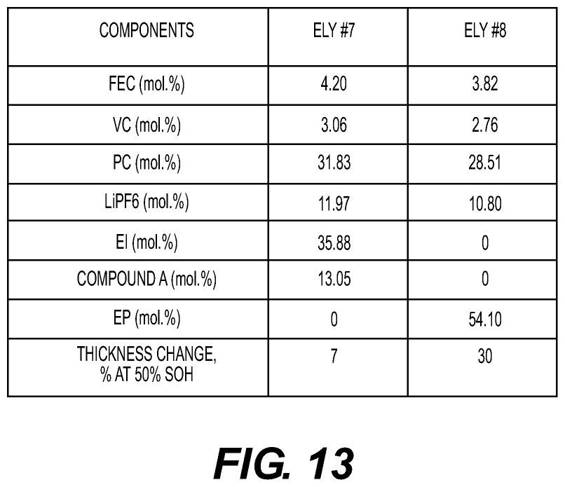

FIG. 13 illustrates the molar composition and thickness change of the cell (expressed in % of the change relative to the initial cell thickness and measured at 50% State-of-health or SOH) of such a cell with ELY #7 that comprises EI (branched ester of Formula 1) and compound A (branched ester additive of Formula 2) and compares it with the inferior thickness change of otherwise analogous cell that comprises ELY #8 with ethyl propionate in its composition.

The above-described exemplary nanocomposite particles (e.g., anode or cathode particles) may generally be of any shape (e.g., near-spherical or a spheroidal or an ellipsoid (e.g., including oblate spheroid), cylindrical, plate-like, have a random shape, etc.) and of any size. The maximum size of the particle may depend on the rate performance requirements, on the rate of the ion diffusion into the partially filled particles, and/or on other parameters. For most applications, the average diffusion distance from the solid-electrolyte interphase (e.g., from the surface of the composite particles) to the inner core of the composite particles may be smaller than about 10 microns for the optimal performance. In some designs, the anode or cathode active material particles may also be of any shape and of any size. In some designs, such particles may be polycrystalline or single crystalline. In some designs, such particles may comprise a surface layer or a surface coating.

Some aspects of this disclosure may also be applicable to Li-ion battery cells with conventional intercalation-type electrodes (e.g., lower voltage cathodes, such as LFP or NMC or LMO or LCO cathodes, or soft carbon, hard carbon, natural graphite or artificial graphite anodes) and provide benefits of improved rate performance or improved cycle stability or improved thermal stability (e.g., operating at elevated temperatures—such as operating at or above around 40-70° C.), particularly for electrodes with medium and high capacity loadings (e.g., greater than about 3-4 mAh/cm²). Some aspects of this disclosure may also benefit some cells (e.g., with LFP or LFMP or LVOP cathodes matched with carbon or graphite-based anodes) that may be built at moderately small to medium areal capacity loadings (e.g., 2-4 mAh/cm²) or higher capacity loadings (above 4 mAh/cm² such as between 4-10 mAh/cm² or 4-12 mAh/cm²) or lower capacity loadings (e.g., below 2 mAh/cm² such as between 1-2 mAh/cm²) in some designs. The above-described exemplary intercalation-type active material particles (e.g., anode or cathode particles) may generally be of any shape (e.g., near-spherical or a spheroidal or an ellipsoid (e.g., including oblate spheroid), cylindrical, plate-like, have a random shape, etc.) and of any size, although typically below around 40-50 micron in average dimensions. The maximum size of the particle may depend on the rate performance requirements, on the rate of the ion diffusion into the partially filled particles, and/or on other parameters.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A Li-ion battery cell, comprising:
anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g;
a separator electrically separating the anode electrode and the cathode electrode; and
an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising:
one or more cyclic carbonates, and
one or more electrolyte co-solvents, at least one of the one or more electrolyte co-solvents having the formula of: 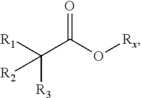
wherein R₁, R₂, and R₃ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy, and wherein Rₓ is C₁₋₅ alkyl.

2. The Li-ion battery cell of claim 1, further comprising:
one or more nitrogen-comprising co-solvents.

3. The Li-ion battery cell of claim 2, wherein:
the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride.

4. The Li-ion battery cell of claim 1, further comprising:
one or more sulfur-comprising co-solvents.

5. The Li-ion battery cell of claim 4, wherein:
the one or more sulfur-comprising co-solvents are selected from tetramethylene sulfone (sulfolane), 1,3,2-dioxathiolane-2,2-dioxide (DTD), methylene methanedisulfonate, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides.

6. The Li-ion battery cell of claim 1, wherein:
the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one.

7. The Li-ion battery cell of claim 1, wherein:
the one or more electrolyte co-solvents are selected from methyl 2-methylpropionate, methyl 2,2-dimethylpropionate (methyl isobutyrate), methyl 2-methylbutyrate, ethyl 2-methylpropionate (ethyl isobutyrate), ethyl 2,2-dimethylpropionate, ethyl 2-methylbutyrate, methyl 2-fluoro-2-methylpropionate, methyl 2-fluoropropionate, methyl 2-methyl-3-cyanopropionate, methyl isovalerate, and ethyl isovalerate.

8. The Li-ion battery cell of claim 1, wherein:
the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

9. A Li-ion battery cell, comprising:
anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g;
a separator electrically separating the anode electrode and the cathode electrode; and
an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising:
one or more cyclic carbonates, and
one or more electrolyte co-solvents, at least one of the one or more electrolyte co-solvents having the formula of: 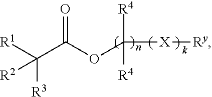
wherein where R¹, R², and R³ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy,
wherein R⁴ is selected from: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy,
wherein n is in the range from 0 to 5,
wherein X is selected from: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, heteroaryl,
wherein p is the range of 0 to 5,
wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl,
wherein k is in the range of 0 to 5, and
wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkyl sulfonyl-C₁₋₅alkyl, N—C₁₋₅alkylsulfonyl-aryl, a 5-8 membered saturated or non-saturated S-containing ring, a 5-8 membered saturated or non-saturated P-containing ring.

10. The Li-ion battery cell of claim 9, further comprising:
one or more nitrogen-comprising co-solvents.

11. The Li-ion battery cell of claim 10, wherein:
the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride.

12. The Li-ion battery cell of claim 9, further comprising:
one or more sulfur-comprising co-solvents.

13. The Li-ion battery cell of claim 12, wherein:
the one or more sulfur-comprising co-solvents are selected from tetramethylene sulfone (sulfolane), 1,3,2-dioxathiolane-2,2-dioxide (DTD), methylene methanedisulfonate, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides.

14. The Li-ion battery cell of claim 9, wherein:
the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one.

15. The Li-ion battery cell of claim 9, wherein:
the one or more electrolyte co-solvents are selected from 2,2,2-trifluoroethyl isobutyrate, 2-cyanoethyl isobutyrate, 2,5-dicyanopentyl isobutyrate, 2-(2,2-dioxido-3H-1,2-oxathiol-4-yl)ethyl isobutyrate, 4-(methyl sulfonyl)benzyl isobutyrate, 2-((difluorophosphoryl)oxy)ethyl isobutyrate, 2-((1,3,2-dioxaphospholan-2-yl)oxy)ethyl isobutyrate, 2-((trimethoxysilyl)oxy)ethyl isobutyrate, 2-(azidomethoxy)ethyl pivalate, allyl isobutyrate, but-2-yn-1-yl propionate, 2,2,2-trifluoroethyl trimethylacetate.

16. The Li-ion battery cell of claim 9, wherein:
the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

17. A Li-ion battery cell, comprising:
anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g;
a separator electrically separating the anode electrode and the cathode electrode; and
an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising:
one or more cyclic carbonates, and
one or more electrolyte co-solvents, at least one of the electrolyte co-solvents having the formula of: 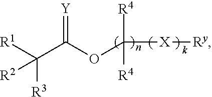
wherein R¹, R², and R³ are independently selected from: H, C₁₋₅ alkyl, halogen, cyano, sulfonyl, alkoxy, trifluoroalkyl, difluoroalkyl, monofluoroalkyl, cycloalkyl, aryl, and aryloxy,
wherein Y is O, S or Se, or S,
wherein Z is O, S, Se or NH,
wherein R⁴ is selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy,
wherein n is in the range from 0 to 5,
wherein X is selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl,
wherein p is the range of 0 to 5,
wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl,
wherein k is in the range of 0 to 5, and
wherein R^{y} is selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkyl sulfonyl-C₁₋₅alkyl, N—C₁₋₅alkylsulfonyl-aryl, a 5-8 membered saturated or non-saturated S-containing ring, and a 5-8 membered saturated or non-saturated P-containing ring.

18. The Li-ion battery cell of claim 17, further comprising:
one or more nitrogen-comprising co-solvents.

19. The Li-ion battery cell of claim 18, wherein:
the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride.

20. The Li-ion battery cell of claim 17, further comprising:
one or more sulfur-comprising co-solvents.

21. The Li-ion battery cell of claim 20, wherein:
the one or more sulfur-comprising co-solvents are selected from tetramethylene sulfone (sulfolane), 1,3,2-dioxathiolane-2,2-dioxide (DTD), methylene methanedisulfonate, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides.

22. The Li-ion battery cell of claim 17, wherein:
the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one.

23. The Li-ion battery cell of claim 17, wherein:
the one or more electrolyte co-solvents are selected from N-(2,2,2-trifluoroethyl)isobutyramide, N-(2-cyanoethyl)isobutyramide, N-(2,5-dicyanopentyl)isobutyramide, 2-(2,2-dioxido-3H-1,2-oxathiol-4-yl)ethyl 2-methylpropanedithioate, O-(4-(methyl sulfonyl)benzyl) 2-methylpropanethioate, S-(2-((difluorophosphoryl)oxy)ethyl) 2-methylpropanethioate, S-(2-((1,3,2-dioxaphospholan-2-yl)oxy)ethyl) 2-methylpropanethioate, trimethyl (2-propionamidoethyl) silicate, N-(2-(azidomethoxy)ethyl)isobutyramide, S-allyl 2,2-di methylpropanethioate, and N-(but-2-yn-1-yl)isobutyramide.

24. The Li-ion battery cell of claim 17, wherein:
the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

25. A Li-ion battery cell, comprising:
anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g;
a separator electrically separating the anode electrode and the cathode electrode; and
an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition comprising:
one, two or more cyclic carbonates, and
one or more electrolyte co-solvents, at least one of the electrolyte co-solvents having the formula of: 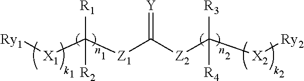
wherein Y is O, S or Se, or S,
wherein Z₁ and Z₂ are independently selected from O, S, Se or NH,
wherein R₁, R₂, R₃ and R₄ are independently selected from the group of: H, C₁₋₅ alkyl, halogen, cyano, cyano-substituted alkyl, bis-cyano substituted alkyl, tris-cyano-substituted alkyl, sulfonyl, alkoxy, azido, isocyanato, isothiocyanato, trifluoroalkyl, difluoroalkyl, monofluoroalkyl, cycloalkyl, aryl, and aryloxy,
wherein n₁ and n₂ are integer numbers which are in the range from 0 to 5,
wherein X₁ and X₂ are independently selected from the group of: —[C(R⁵)₂C(R⁵)₂—O]ₚ—, —[C(R⁵)═C(R⁵)₂]ₚ—, —[C(R⁵)₂—C(R⁵)═C(R⁵)]ₚ—, —[C(R⁵)C(R⁵)]ₚ—, aryl, and heteroaryl,
wherein p is the range of 0 to 5,
wherein R⁵ is selected from the group of: H, C₁₋₅ alkyl, halogen, cyano, cyano-substituted alkyl, bis-cyano substituted alkyl, tris-cyano-substituted alkyl, sulfonyl, alkoxy, trifluoroalkyl, difluoroalkyl, and monofluoroalkyl,
wherein k₁ and k₂ are integer number which are in the range of 0 to 5, and
wherein Ry₁ and Ry₂ are independently selected from the group of: C₁₋₅ alkyl, aryl, heteroaryl, halogen, trifluoromethyl, difluoromethyl, fluoromethyl, cyano, azido, isocyanate, isothiocyanate, C₄₋₇ cycloalkyl, sulfonyl-C₁₋₅alkyl, sulfinyl-C₁₋₅alkyl, N—C₁₋₅alkyl sulfonyl-C₁₋₅alkyl, N—C₁₋₅ alkylsulfonyl-aryl, a 5-8 membered saturated or non-saturated S-containing ring, and a 5-8 membered saturated or non-saturated P-containing ring.

26. The Li-ion battery cell of claim 25, further comprising:
one or more nitrogen-comprising co-solvents.

27. The Li-ion battery cell of claim 26, wherein:
the one or more nitrogen-comprising co-solvents are selected from dimethylacetamide (DMAc), 3-{[1,3-bis(2-cyanoethoxy)propan-2-yl]oxy}propanenitrile (CEPOPN), 1,5-dicyanopentane, 4,4-dimethylheptanedinitrile, 1-(cyanomethyl)cyclopropane-1-carbonitrile, 1,4-dicyano-2-butene, trans, 3-(2-cyanoethoxy)propanenitrile, ethylene glycol bis(propionitrile)ether (EGBE), fumaronitrile (FM), succinonitrile, glutaronitrile, adiponitrile, p-toluenesulfonyl isocyanate, 1,1′-sulfonyldiimidazole, 1,3,6-hexanetricarbonitrile (HTCN), pyridine boron trifluoride (PBF), 3-fluoro pyridine boron trifluoride (3F-PBF), and pyrazine boron trifluoride.

28. The Li-ion battery cell of claim 25, further comprising:
one or more sulfur-comprising co-solvents.

29. The Li-ion battery cell of claim 28, wherein:
the one or more sulfur-comprising co-solvents are selected from tetramethylene sulfone (sulfolane), 1,3,2-dioxathiolane-2,2-dioxide (DTD), methylene methanedisulfonate, trimethylene sulfate, terthiophene, sulfonyldiimidazole, ethylene sulfite, phenyl vinyl sulfone, propane sultone, propene sultone, phenyl vinyl sultone, linear sulfonic esters, linear sulfones, dimethyl sulfone, ethylmethyl sulfone, sulfoxides.

30. The Li-ion battery cell of claim 25, wherein:
the one or more cyclic carbonates are selected from fluoroethylene carbonate (FEC), ethylene carbonate (EC), vinylene carbonate (VC), vinyl ethylene carbonate (VEC), propylene carbonate (PC), 4-ethyl-1,3-dioxolan-2-one, 4,5-dimethyl-1,3-dioxolan-2-one, 4,4-dimethyl-1,3-dioxolan-2-one, and 4-propyl-1,3-dioxolan-2-one.

31. The Li-ion battery cell of claim 25, wherein:
the one or more electrolyte co-solvents are selected from bis(4-(methylsulfonyl)benzyl) carbonate, 2,2,2-trifluoroethyl (2-cyanopropyl)carbamate, cyanomethyl (2-((trimethoxysilyl)oxy)ethyl) carbonate, 2-(2,2-dioxido-3H-1,2-oxathiol-4-yl)ethyl methyl carbonate, and S-allyl methylcarbamothioate.

32. The Li-ion battery cell of claim 25, wherein:
the one or more Li salts are selected from Li hexafluorophosphate (LiPF₆), Li bis(fluorosulfonylimide) (LiFSI), Li bis(trifluoromethanesulfonylimide) (LiTFSI), Li bis(perfluoroethylsulfonylimide) (LiBETI), one or more other Li imide salts, Li bis(oxalatooxalate)borate (LiBOB), Li difluoro(oxalatooxalate)borate (LiDFOB), Li 2-trifluoromethyl-4,5-dicyanoimidazolide (LiTDi), Li 4,5-dicyano-2-(pentafluoroethyl) imidazolide (LiPDi), Li difluorophosphate (LiDFP), Li nitrate (LiNO₃), lithium azide (LiN₃), lithium tetrafluoroborate (LiBF₄), and trifluorochloroborate (LiBF₃Cl).

33. A Li-ion battery cell, comprising:
anode and cathode electrodes, wherein the anode electrode has a capacity loading in the range of about 2 mAh/cm² to about 10 mAh/cm² and comprises anode particles that (i) have an average particle size in the range of about 0.2 microns to about 20 microns, (ii) exhibit a volume expansion in the range of about 8 vol. % to about 180 vol. % during one or more charge-discharge cycles of the battery cell, and (iii) exhibit a specific capacity in the range of about 800 mAh/g to about 3000 mAh/g;
a separator electrically separating the anode electrode and the cathode electrode; and
an electrolyte ionically coupling the anode electrode and the cathode electrode, wherein the electrolyte comprises one or more metal-ion salts and a solvent composition, the one or more metal-ion salts including one or more Li salts with a total concentration of the Li salts in the electrolyte in the range from about 0.8M to about 2.0M, the solvent composition having a density in the range from about 0.8 g/cc to about 0.95 g/cc or from about 0.95 g/cc to about 1.00 g/cc or from about 1.00 g/cc to about 1.05 g/cc.

34. The Li-ion battery cell of claim 1, wherein the solvent composition further comprises a phosphorous-comprising compound.

35. The Li-ion battery cell of claim 34, wherein the phosphorous-comprising compound comprises a phosphite.

36. The Li-ion battery cell of claim 35, wherein the phosphite comprises tris(trimethylsilyl) phosphite.

37. The Li-ion battery cell of claim 9, wherein the solvent composition further comprises a phosphorous-comprising compound.

38. The Li-ion battery cell of claim 37, wherein the phosphorous-comprising compound comprises a phosphite.

39. The Li-ion battery cell of claim 38, wherein the phosphite comprises tris(trimethylsilyl) phosphite.

40. The Li-ion battery cell of claim 17, wherein the solvent composition further comprises a phosphorous-comprising compound.

41. The Li-ion battery cell of claim 40, wherein the phosphorous-comprising compound comprises a phosphite.

42. The Li-ion battery cell of claim 41, wherein the phosphite comprises tris(trimethylsilyl) phosphite.

43. The Li-ion battery cell of claim 25, wherein the solvent composition further comprises a phosphorous-comprising compound.

44. The Li-ion battery cell of claim 43, wherein the phosphorous-comprising compound comprises a phosphite.

45. The Li-ion battery cell of claim 44, wherein the phosphite comprises tris(trimethylsilyl) phosphite.
